(19) United States
(12) Patent Application Publication
(10) Pub. No.: US 2007/0106551 A1
(43) Pub. Date: May 10, 2007

(54) 22nets: method, system, and apparatus for building content and talent marketplaces and archives based on a social network

(76) Inventor: Elliot McGucken, Malibu, CA (US)

Correspondence Address: Dr. ELLIOT MCGUCKEN, 24345 BAXTER DRIVE, MALIBU, CA, 90265-4753, US

(21) Appl. No.: 11/523,309

(22) Filed: Sep. 19, 2006

Related U.S. Application Data
(60) Provisional application No. 60/718,921, filed on Sep. 20, 2005.
(60) Provisional application No. 60/755,927, filed on Jan. 3, 2006.
(60) Provisional application No. 60/792,107, filed on Apr. 15, 2006.

(51) Int. Cl. G07G 1/00

(52) U.S. Cl. 705/10

(57) ABSTRACT

The novel social network described herein allows content creators, as well content aggregators and network builders, to profit in novel manners. A method and system allows users, who create content archives and marketplaces in which individuals and content in the database are connected by mutually defined relationships determined by the content creators/owners, uploaders, aggregators, and/or viewers of said content, to better profit from the networks they build. Higher-quality archives and marketplaces result. A tiered commission system, proportional to the degrees of separation in the network, provides a revenue share for creators and viewers who participate in and create content and/or marketplaces. Information inherent within the nodes is mined so as to afford a tiered revenue-sharing system. An improved method of content distribution empowering creators of content and participants is disclosed herein, along with a superior social network.

### CROSS-REFERENCE TO RELATED APPLICATIONS

This application claims the benefit of provisional patent applications Ser. No. 60/718,921 filed Sep. 20, 2005 by the present inventor, Ser. No. 60/755,927 filed Jan. 3, 2006 by the present inventor, and Ser. No. 60/792,107 filed Apr. 15, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to online social networks, content, and ecommerce and, more particularly, to marrying content to social networks so as to foster novel marketplaces and opportunities for artists, creators, aggregators, and producers, thusly empowering content creators, producers, and aggregators in novel ways. The present invention allows creators and individual participants in social networks to more readily extract the value within the network they participate in creating. An algorithm in the present invention fosters new business models, and via the modification the algorithm offers to the crowded field of social networking system, far-ranging consequences in the realm of ecommerce are implied and can be realized. The present invention empowers indie creators as never before, and encourages new kinds of higher-quality social networks where users profit from sales of content and advertising around their content in social networks that they participate in and build.

The present invention is directed to a networked database having a plurality of records corresponding to individuals and associated creative works and content, more particularly to a networking database in which the records of music, art, photography, poetry, and literature are inter-linked by defined relationships to other creative works and individuals. The present invention allows creators to extract novel value from the inherent value within the network they create—a value which is approximated by Metcalfe's law. Thus the system encourages enhanced creator participation via monetary incentives, thereby enhancing the overall value of the system, attracting better-quality content, and providing commercial value to this present invention.

The simple act of marrying content marketplaces to a social network will afford brand new business models and hitherto unseen business opportunities for users of said social network. The algorithm described herein allows the marriage of social networks to content marketplaces to compensate participants in the social network according to the natural information embodied in the relationships between nodes on a network.

Furthermore, the simple act of offering users of a novel social networking system a full spectrum of digital rights management will allow such a social networking system to excel beyond the prior art in creating profitable business models. Either of these two modifications disclosed in this present invention, when applied in the crowded field of social networks, will allow for the creation of improved, superior social networks in overall quality and business opportunities for users and owners of said social networks. And too, either modification will bolster the business models of existing social networks.

The present invention is an end product of multiple years of Dr. Elliot McGucken's research into both open source and proprietary methods for content and rights management and social networking. Dr. McGucken has spoken at the Harvard Law School's Berkman Center for Internet and Society regarding his Open Source DRM project Authena.org at the oscom.org conference—the present invention offers an improvement over the IP disclosed throughout the Authena.org project. Dr. McGucken's 22surf.org Open Source business plan has been downloaded and read by thousands, and it was accepted into the Zurich OSCOM: http://sourceforge.net/projects/authena22surf. The present invention is an improvement upon Dr. McGucken's prior art. Dr. McGucken appeared on a panel aside John Whealan—Deputy General Counsel for Intellectual Property Law & Solicitor USPTO, and Marybeth Peters—U.S. Register of Copyrights, where he spoke about the fundamental Constitutional concepts underlying the present invention—a video of this panel may be viewed at: http://www.unctv.org/ipcip/: UNC Symposium on Intellectual Property, Creativity and the Innovation Process.

Dr. McGucken devised and is currently teaching a course, Artistic Entrepreneurship & Technology: artsentrepreneurship.com, which would be well-served by the present invention. Indeed, the common problem of so many rising artists is securing and monetizing their creations. This present invention assists rising creators by providing novel methods by which they can protect and profit from their creations.

Thousands of rising artists have little or no means to protect their content before releasing it on the web, where digital content may be copied ad in finitum. A purpose of this invention is to offer artists the ability to use DRM in protecting their content. Vast media companies including Google™ and Myspace™ have business models that rely upon freely copying others' content. Creators are told that there is little or no value in their creation as it stands alone, but only within the context of the greater group. The media and Wall Street have been successful in convincing creators to work for free in building out web 1.0 and web 2.0, just as traditional record companies have oft been successful in convincing artists to work for free in building traditional record labels. The present invention, by combining existing technologies in novel ways that counter expert opinion, provides a superior means for artists to protect and profit from their work, and for participants in social networks to profit from their participation.

Whereas former social networks and web 1.0/2.0 content archives have first and foremost focused on enriching the owners of the social network, the novel 22nets system of this present invention focuses on enriching the content and network creators—those who are building the true value of the web. An overarching principle of the present invention is that by focusing on enriching creators, the network as a whole is strengthened, and is able to attract more and better creators, who can create trusted networks and upscale brands. A rising tide lifts all boats, and the network/archive/marketplace which best empowers its creators will become the best network/archive/marketplace.

Whereas Web 2.0 is often about mob-rule and myspace business models being driven by teenage girls posting pictures in underwear, web 3.0, and more importantly 4.0 and 5.0, will be about classic storytelling and the classical ideals rooted in the United States Constitution and the Great Books and Classics. The same philosophy underlying property rights and property law that enabled this country to become the world's most prosperous are at the center and circumference of this present invention. All creators should be given the opportunity to own and protect what they create, as well as the opportunity to associate with other creators, and thus build trusted content marketplaces.

The United States Constitution states:
The Congress shall have Power to promote the Progress of Science and useful Arts, by securing for limited Times to Authors and Inventors the exclusive Right to their respective Writings and Discoveries;—The United States Constitution, Section 8, Clause 8

By adhering to Constitutional principles, this present invention offers a novel contribution to the realm of social networking and content markets and archives. For instance, the Constitution does not state that Myspace, nor Youtube, nor Google, nor Web 2.0 companies, nor record labels, nor academic communists, nor packs of lawyers and MBAs should be the primary owners nor beneficiaries of the labors of artists, authors, creators, and inventors. Instead, the United States Constitution states that “The Congress shall have Power to promote the Progress of Science and useful Arts, by securing for limited Times to Authors and Inventors the exclusive Right to their respective Writings and Discoveries.”

Although prestigious legal/tech experts including Cory Doctorow of the EFF and Lawrence Lessig of Stanford Law School oppose it, the technology exists to offer creators better and improved methods for protecting content and defining rights, and the present invention's novel combination of existing technologies results in brand new technologies and novel business methods. Although prestigious legal/tech experts including Cory Doctorow of the EFF and Lawrence Lessig of Stanford Law School oppose digital rights management (DRM) on multiple levels, digital rights management (DRM) may be offered in the present invention so as to empower individual creators.

The United States Constitution does not say that MBAs and lawyers, working in either communistic or capitalistic business models, should be able to seize the inherent value within a creator's works. Instead, the United States Constitution seeks to protect the rights of the individual creator, as the Founding Fathers realized that the individual is the goose that lays the golden egg.

In The Mystery of Capital, Why Capitalism Triumphs in the West and Fails Everywhere Else, by Hernando De Soto, Mr. Desoto ties the spirit of capitalism to “processes buried deep within the legal system.” A subheading in the introduction is, “The mystery of legal failure—why property law does not work outside the west.”

Property law of the West is interlinked with the deep-rooted, abstract values of the Judeo Christian heritage, centered about such simple precepts as “Thou shall not steal.” This overarching shared-faith allows the abstract ownership of property represented in talents and deeds to become effectively real—all paper wealth comes from a commitment to abstract principles. Individual ownership offers the individual incentive to protect, and thus the West has fathered the strongest economies and military powers. It is no mystery that the country with the right to free speech, free religion, and the right to bear arms also has the most powerful economy and system of property rights. The present invention extends these fundamental, classical, Constitutional principles onto the net, combining existing technologies in unique ways, thusly offering creators novel means for protecting and disseminating their work. This in turn leads to improved and hitherto unknown business models.

The fundamental right to own private property—to own and profit the fruits of one's labors—is the heart and soul of Western Capitalism. The present invention serves this fundamental spirit in a superior fashion to all existing and prior art.

Creators are currently leaving billions of dollars on the table in the present system—billions of dollars that they truly deserve, as they are the creators. And should the creators receive the money they rightfully deserve, they will create more, thusly increasing the net wealth of the internet and the world. The present invention helps them collect the billions of dollars that is rightfully theirs.

Google maintains a complete copy of the web, and they are attempting to make full copies of millions of books protected by copyright. Google's patented link algorithms have fostered and encouraged vast amounts of link spam, fake spam pages, fake blogs, blog spam, spam bits, and vast innovations in spam. A better model could consist of a search engine having to pay content owners for each and every copy made, and each and every copy served. Thus the novel search engine would be encouraged to exclude link farms, fake blogs, and link spam from their database, resulting in better search results and higher-quality content. By allowing a user to define the rights to their work, such a search engine could be worked toward.

Chris Anderson of Wired Magazine recently wrote a well-received book, The Long end of The Tail. The book's cover flap states,
“In short, though we still obsess over hits they are not quite the economic force they once were. Where are those fickle consumers going instead? No single place. They are scattered to the winds as markets fragment into a thousand niches. . . . Now, in this highly anticipated book, Anderson shows how we got to this point, and the huge opportunities that exist: for new producers, new aggregators, and new tastemakers . . .”

There exist two entities which Mr. Anderson's bookflap fails to mention, and which Mr. Anderson's book does not discuss. One is the individual creator—those who actually create the content for the “producers, aggregators, and tastemakers” to play with and profit from. The other entity Mr. Anderson forgets to mention is digital rights management or DRM. For while non-DRM systems empower the aggregators such as the early Napster and Youtubes temporarily, and while groupthink search engines such as yahoo and google have little need for the indie creator, a long-term solution is going to have to sooner or later respect the rights of the individual creator. Indeed, neither digital rights management nor DRM can be found in the index of Mr. Anderson's book, which seems to be a glaring omission in that DRM is the only reason major labels or major recording artists or major Hollywood studios will ever convinced to distribute their content online. Kid Rock and Sir Paul McCartny are individuals seeking to be paid for their work, as are thousands of other artists—many of whom are quoted below. The present invention—22nets—seeks to serve them with an improved method for protecting and distributing their content.

Also quoted below are prestigious experts including Larry Lessig—the founder of the Creative Commons and renown Stanford Law professor, as well as Corey Doctorow—the famous blogger, writer, member of the EFF, and influential speaker on topics pertaining to DRM who has addressed many organization, including Microsoft, regarding DRM. While the vast, vast majority of artists support stronger protections for their works, both Lessig and Doctorow, who represent the majority opinions of the web 2.0 tech denizens and their loyal MFA/MBA fanboys, are vocally opposed to Digital Rights Management. Lessig's and Doctorow's vocal opinions have a far-reaching influence throughout the tech world, and the spirit of the present invention counters and opposes their vocal oppositions to DRM. Indeed, the prevailing views of Lessig, Doctorow, and others can explain in part why the present invention, serving the interests of the creators, has not yet seen been manifested. But eternity is on truth's and beauty's die, and the cost of computer applications tends towards zero-so it is that DRM will someday be free as the wind, while art and the individual will never be a commodity; and this invention fully capitalizes upon the proper perspective. While web 2.0 companies seek to commoditize the creator, the present invention treats the creator as unique while commoditizing the web 2.0 companies.

Lessig's and Doctorow's opinions are more fully discussed, as are the objects and advantages of the present invention. Very briefly, here is Corey Doctorow's expert view which was presented during a speech to Microsoft and translated into a dozen languages http://www.craphound.com/msftdrm.txt:

Here's what I'm here to convince you of:
1. That DRM systems don't work
2. That DRM systems are bad for society
3. That DRM systems are bad for business
4. That DRM systems are bad for artists
5. That DRM is a bad business-move for MSFT
   Microsoft Research DRM talk, Cory Doctorow, cory@eff.org, Jun. 17, 2004, This talk was originally given to Microsoft's Research Group and other interested parties from within the company at their Redmond offices on Jun. 17, 2004.

Very briefly, the present invention counters Cory's conventional web 1.0/web 2.0 wisdom by stating:
1. DRM does work
2. DRM systems are good for society
3. DRM systems are good for business
4. DRM systems are good for artists
5. DRM is a good business-move for MSFT
6. DRM is the missing key to long-term profitability for social networks.
7. DRM is the missing key to better content on the web.
8. DRM that best serves the indies creator will also best serve the major creators.
9. DRM will allow better “fair use” systems where property that is tagged can be shared and included in other works while still compensating the original creator.
10. DRM can help foster a unique and novel business models including social networks and content marketplace.

Unlike prior art, this present invention realizes both the full value of the internet and the United States Constitution, by affording authors, artists, and creators the fullest potential to create and profit from social networks and marketplaces filled with content they and other artists create and protect.

2. Prior Art

No prior art, nor any entity at any of the most prominent technology conferences, including (sxsw.com/interactive/) and web 2.0 con (http://www.web2con.com/pub/w/40/coverage.html) has yet suggested offering the creator a full spectrum of digital rights management. No prior art, nor any entity at any of the most prominent technology conferences, including (sxsw.com/interactive/) and web 2.0 con (http://www.web2con.com/pub/w/40/coverage.html) has yet suggested offering the creator a full spectrum of digital rights management for free. DRM ought to be free, as it is based on mathematical algorithms which are free as the wind.

Indeed, when I asked about providing creators with a full-spectrum of DRM options at SXSW, my question was met with groans, as I knew it would be—I was just trying to demonstrate that leading expert opinion countered the spirit of this present invention. One panel went on to say that DRM is bad, but that iTunes is good even though it uses DRM, because some men are more equal than others. The creator is not to be trusted with something as dangerous as DRM in these contexts—only Steve Jobs is allowed to use DRM, because he is cool and hangs out with Bono, and because he is working with the major labels, who deserve more and better rights than the individual. Rising rap bands and metalheads must be denied the right to use DRM according to present expert opinion elaborated on throughout this present disclosure of invention.

While social networks such as myspace™, facebook™, and friendster™ abound, their short-term and long-term profitability, based mostly on the aggregation of eyeballs, is uncertain. Furthermore, while the insiders and founders of said networks cash out in various deals, those creators and users who actually build the networks rarely, if ever, profit form their creations. While content aggregators such as lulu.com™, youtube.com™, and revver.com™, aggregate content, their long-term and short-term profitability remain in question. All of the above services, as do many others, limit the users' freedom, as they fail to offer the user a full spectrum of digital rights management, and they fail to offer the user an easy means to transmit content from one social network or content archive/system to another, and they fail to offer the user the ability to profit more directly off a social network the user builds within the system, by selling content linked to the social network. Furthermore, none of the services offer a tiered commission structure by which one can profit from content sold within one's network.

Furthermore, while vast amounts of advertising may be sold on social networks, rarely, if ever, are the creators compensated proportionally to the amount of advertising sold. Indeed, the creators are building the social networks and the web, but rarely profiting from it. The present 22nets invention is novel in that it is creator-centric, as opposed to other existing systems which are all about enriching the aggregators by limiting the creators' natural freedom and profits. Digital content naturally wants to be free—that is free to have rights defined by the creator—and yet existing social networks and content aggregators seek to lock the content within their systems, while failing to provide creators means to define the rights to their content. For instance, once a video is uploaded to revver™ or youtube™ or myspace™, the original cannot be retrieved. Furthermore, it cannot be watermarked with the creator's brand. Furthermore, the creator cannot select the proper digital rights definitions for it—the creator cannot set a price, nor define how many times it can be played, copied, burned to physical media, or traded on p2p networks. The present 22nets invention offers creators means to define the rights of their content, and then set it free to participate in any other social networking or content aggregating service that serves the creator. The 22nets system pays those who are building the web—the 22nets system enriches the creators first and foremost, granting them a hitherto unseen power via rights definitions, and thus providing a novel opportunity for superior and hitherto unknown business models.

The following excerpts from leading publications and blogs illustrate the shortcoming of the current systems embodied in the Priot Art:

Wired Magazine reports at: http://www.wired.com/wired/archive/14.07/murdoch_pr.html:
Perched on the edge of a bright white power sofa on the supernaturally quiet eighth floor of the News Corporation's global headquarters, the last thing Rupert Murdoch looks like is a fire-eyed revolutionary. Starched cuffs. Courtly manner. A month past his 75th birthday. But then he starts talking. “To find something comparable, you have to go back 500 years to the printing press, the birth of mass media—which, incidentally, is what really destroyed the old world of kings and aristocracies. Technology is shifting power away from the editors, the publishers, the establishment, the media elite. Now it's the people who are taking control.” And he's smiling . . . MySpace was big: 20 million people had signed up, and 100,000 more were arriving every day. And it was busy: 6.2 billion pageviews a month made it the fifth-most-visited site in the US from a standing start 18 months earlier. Added bonus: totally viral marketing and zero content costs.—http://www.wired.com/wired/archive/14.07/murdoch_pr.html

So there you have it. Myspace—the definitive new media company—does not pay the creators. Rupert Murdoch is smiling because, “Added bonus: totally viral marketing and zero content costs.” That would be zero content costs to Murdoch, but billions in costs to the collective creators who spend countless hours composing music, recording songs, writing blogs, taking photos, and building myspace.

Not only does myspace, like the rest of the social networks, not pay the creator for the content they upload—the content that is responsible for the billions of myspace's pageviews as well as all their advertising revenue—but myspace also does not provide tools for watermarking, rights definitions, and digital rights management.

Furthermore, myspace, and every other content aggregator and social network, fail to empower the creator and the network builder by allowing them to sell content associated with the social network they create. The present invention allows users to sell and profit from content tied to the social network they create.

The present invention—22nets—seeks to allow artists to protect and charge for all content that is uploaded: the present invention offers a solution to a long-felt need—to allow artists to profit from their creations. Below are what some of the artists are saying, from http://www.riaa.com/about/artists/quotes.asp. Their quotes reflect the need for artists of all kinds, from photographers, to musicians, to indie filmmakers, to be afforded the opportunity to protect and profit from their content in this digital age. This present invention serves the long-felt need, without an obvious solution, to better protect and profit from one's creative labors and creations.
“The fundamental point is: no music, no Napster. This is obviously a big business that was built by taking stuff without the consent of the artists who created it . . . . More and more people are going to download their music, and if it all stays free and there is no control over the payments, then it will be difficult for younger artists to make a livelihood . . . . We would first like to be consulted before our stuff gets taken, and [we'd like to] have some vote in deciding what's distributed for free and what isn't . . . . Second, we'd like to get some payment.”—Peter Gabriel The Red Eye/Redherring.com Feb. 5, 2001
“I don't like to have a record out and have people hear . . . versions that we don't want them to hear. With the Internet, there is no more privacy and not even the chance to express yourself in front of your audience in the intimacy of a concert that lets songs evolve. You can't do this because they immediately get circulated.”—Neil Young Yahoo! Entertainment News Jan. 31, 2001
“You know, my whole vibe on Napster is, I understand how it will help life for unsigned bands. It is definitely a window to showcase a lot of bands [that] probably wouldn't be getting to hear from a lot of these majors, but at the same time you all need to pay us now . . . I mean, straight up! This is some hard work. I mean, I was in the military for, like, four years, man, and I'm telling you, boy, the music business is some hard work . . . . You need some sort of pension, you know? And if they can't regulate it to where the artist gets paid, well, then it's not that great of an idea because even the unsigned artists, at some point, they're going to want to get paid for their things also.”—Shaggy Feb. 2, 2001
“The bottom line is this; The works of recording artists are being stolen and disseminated over the Internet without fair and just compensation for those artists. This is the way songwriters and singers make their living, and stealing that music and giving it away for free is not right. Then there's the absurd argument that, ‘Well, rock stars are wealthy, and therefore, it's all right to steal from them.’ But the majority of singers and songwriters and recording artists in this business are not wealthy. They're struggling from hand to mouth, day to day, and they need fair and just compensation for their work. I'm deeply concerned, as are all artists about these issues, particularly Napster.”
—Don Henley Boston Globe May 5, 2000
“The Internet is both a democratizing force and a force for undermining democracy. The concept that music should be free is some holdover from the Sixties, I guess. And I resent it when people imply that this is not a legitimate profession, that what I do for a living should be given away. Napster and MP3.com try to make people believe that they are some sort of Robin Hood organization, stealing from the record companies and giving music to the people. But they are stealing from the people who create that music.
—Don Henley Rolling Stone Jun. 22, 2000
“ . . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to ‘stop technology. I love technology. Technology is here to stay . . . ”—Trent Reznor of Nine Inch Nails Boston Globe May 5, 2000
“ . . . Yeah, I feel like I'm being stolen from, and I'd like to knock that punk around that invented it, but it was bound to happen . . . I think Metallica's got the right idea sue 'em. It's your copyright, it is copyright infringement, and even though Napster is only the pipeline . . . ”—Johnny Rzeznik of the Goo Goo Dolls Sonicnet.com Jun. 7, 2000
“I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s--t for free. That Napster s--t, if that gets any bigger, it could kill the whole purpose of making music. It's not just about the money. It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD.”—Eminem Wall of Sound May 17, 2000
“ . . . [But] right now, if it's affecting anybody, it's affecting a band like us. Metallica sells millions of records, you know what I mean? They're not in the hot seat as much as we are . . . . Our new record, it hasn't even come out yet, and I'm sure probably a quarter of our fan base have already heard it. We just have to hope these people still buy our record when it comes out, but it's kind of scary for us.”—Chino Moreno of the Deftones Sonicnet.com Jun. 7, 2000
“In the genre of music that *NSync does, fans want more than just the record. They want the whole package, they want the packaging and the credits and the pictures and the thank you's because they're true fans of the band so they want to have a memento of everything the guys wanted for their fans. So if you can download it off the Net, yeah, you're going to get the music, but you're not going to get the other things. So I think in some cases, it wouldn't be as big of an impact on us because of the fans that we reach. But still, if somebody is going to work on their craft, they should have the opportunity to benefit from the rewards of their work, and not have someone put it up on the Net so people can steal it.”—Johnny Wright, *NSync manager Sonicnet.com Jun. 7, 2000
“ . . . there should be some way that Napster compensates the artists. Because obviously they wouldn't be providing a service if they weren't getting compensated, it's not a free service, it's not like it's done just to please fans. Everything that's done is done for a profit.”—Scott Weiland of Stone Temple Pilots Sonicnet.com Jun. 7, 2000
“It's not even just about money, the quality is lesser. That's not good. We work really hard to make the music sound good, so we want people to hear it the way it actually sounds. So I would give it a thumbs down.” [sonicnet.com: “MP3s are actually close to CD quality.”] “Oh, well, still thumbs down.”
—Arion Salazar of Third Eye Blind Sonicnet.com Jun. 7, 2000
“It sounds kind of parochial to say this, but you have to play by the rules. There's rules that have been established over a long period of time. The rules aren't always the right rules, but you have to [follow them] . . . If [Public Enemy rapper and Napster supporter Chuck D] can figure out a way to get paid somehow with music getting downloaded without people having to pay for it, then good for him. That doesn't work for me, I've got three kids now.”—Jimmy Jam, producer Sonicnet.com Jun. 7, 2000
“It totally pisses me off, because musicians get hardly any money from this at all. I could make more money washing dishes at the moment. It's unfair . . .”
—Dandy Warhols guitarist Peter Holmstrom Sonicnet.com Jun. 7, 2000
“It's beneficial and unfortunate at the same time. It's beneficial because people are getting into your music. It's unfortunate because it's harder to keep control of your music and your career.”—Ideal singer P. Z. Sonicnet.com Jun. 7, 2000
“The foundation of every industrial country is the preservation of property rights, and it boils down to that. So I'm not really sure why intellectual property would be an exception.”—Tal Bachman Sonicnet.com Jun. 7, 2000
“Maybe there's some really independent cool band that by this method gets some word around. The problem is, in the future, how are they going to make it? Maybe they think they can make money from their performances, but I don't know if that's something you can count on.”—Green Velvet (a.k.a. Cajmere) Sonicnet.com Jun. 7, 2000
“I am excited about the opportunities presented by the Internet because it allows artists to communicate directly with fans. But the bottom line must always be respect and compensation for creative work. I am against Internet piracy and it is wrong for companies like Napster and others to promote stealing from artists online.”—Elton John
“Artists, like anyone else, should be paid for their work.”—Lou Reed
“Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.”—Lars Ulrich of Metallica
“As an artist and songwriter I believe that this is an issue that needs to be looked at and taken very seriously. In what other industry can someone take a product, not created by themselves, make money from the use of that product and not compensate the original creator? Someone needs to take a stand and protect the songwriters and artist.”—Victoria Shaw, country music singer/songwriter
“I think the fact that Napster is stealing recorded music is something that we have to stop. It's taking money out of my kid's mouth. That's the way I look at it. It's wrong. It's inherently wrong. It's stealing.”—Art Alexakis of Everclear
“As a band, we are incensed at the amount of disregard Napster has toward how musicians make a living. We only get paid from our recordings if they are bought in legal ways. By disregarding copyright laws we lose out. We are a ‘baby band’, struggling to stay alive financially. Every dollar we lose to “fans” stealing our music hurts . . . if folks knew that the majority of the major label bands are not making any income from their recordings . . . and losing money by touring, they would be astounded and a bit more sympathetic to the artists. What is supposed to set the industry free is killing it.”—The Push Stars
“There are laws against piracy in this country, and unless we enforce them, how do we expect any other country to care about protecting our rights from piracy?”
—Denyce Graves, RCA Victor Red Seal, Classical recording artist
“Everyone I know is excited about all the possibilities the Internet has to offer. As a musician, the Internet has made it possible for me to share my music with people that could have never been reached by conventional methods. It has been taboo for artists to speak out concerning the business side of their music. The fear has been that the buying public, as well as other artists, would perceive this concern as greed, and that the artists' sole purpose for creating was the money. This perception has silenced many artists concerning MP3 and Napster. The silence must end. As a child I created music to express my inner thoughts and feelings, and that purity has stayed with me throughout. The day I decided to share my music with the world, was the day I decided to walk the fine line between art and commerce. I have been blessed in that I do what I love and can support my family with what I create. When my music is given away, as taboo as it is for me to say, it is stealing. I need not defend my motives for making music, but the distribution of my music has made me business conscious. I have decided to sell my music to anyone who wants it, that is how I feed my family, just like a doctor, lawyer, judge, or teacher. Not to insult anyone's intelligence, but my music is like my home. Napster is sneaking in the back door and robbing me blind.”—Scott Stapp, lead singer/lyricist for Creed
“It's high-tech bootlegging, with artists definitely losing revenue. I appreciate that people like my music enough to download it. But we need to join forces and fight this.”
—DJ Scratch, artist/producer Billboard Apr. 15, 2000
“[Napster] is particularly discouraging to young artists and songwriters trying to get their foot in the proverbial door of the music business. I suppose it should be a compliment that people dig your music so much that they're swapping it online. But thievery is thievery. If you dig an artist that much, then you should want to help keep that artist alive by purchasing the actual recording.”—Anastacia, Daylight/Epic recording artist Billboard Apr. 15, 2000
“If artists don't get paid for making music, how are they supposed to survive? Stealing from an artist is not the best way to show your appreciation for their work.”—Aimee Mann Entertainment Weekly Mar. 31, 2000
“Artists should be compensated for the work that they do.”—Deborah Harry of Blondie Salon Mar. 25, 2000
“No matter what you do for a living you should get paid for your work, whether you're washing dishes or recording songs.”—Bif Naked Salon Mar. 25, 2000
“Nobody wants to look the artist in the eye and say, ‘Giving your music away for free is going to make you lots of money’—not while keeping a straight face, anyway.”—Kristin Hersh, Throwing Muses Salon Mar. 25, 2000
“Artists should be compensated for their work and protected against a technology that allows copyrighted music to be illegally downloaded. But Napster and technologies like it are just a part of the overall problem. Intellectual property in the Internet Age must be staunchly protected. Without meaningful safeguards, the livelihood of the creative community is at risk.”—Mike Greene, President and CEO National Academy of Recording Arts and Sciences
“ . . . We send them [artists] to Napster and they see all their work being given away for free, and they're stunned and horrified. What disturbs me the most is that artists are never discussed. Artists just seem to be a ping-pong ball whacked back and forth and nobody gives a fuck about them . . . . And it turns out Napster's no better than the record companies. In fact, they're worse, because they're offering nothing and taking everything. Napster's the tip of the iceberg. The broader question is intellectual property on the Internet. Intellectual property should be valued and protected or we'll go down. And not just music either. Why would anybody sit down and write a novel it it's going to be pirated for free the first day it's released. If nobody values intellectual property, then we'll all be in the insurance business.”—Ron Stone, Gold Mountain Management (represents Bonnie Raitt, Tracy Chapman, Ziggy Marley and others) Salon Mar. 25, 2000
“The artists, writers, and labels aren't being compensated. It's certainly not the way copyright laws were set out to work . . . when managers and artists and labels have no control and it's a free-for-all out there, it's problematic.”—Mike Robertson, Mike Robertson Management (represents Nitty Gritty Dirt band, Wade Hayes, BlackHawk and others) Billboard Apr. 15, 2000
“All of a sudden a song could get out without the act's knowledge or the label's knowledge, and all the hard work that's been put into the project is then lost.”—Ken Crear, Creative Management Group (represents Next, Sisqo, Mary Mary and others) Billboard Apr. 15, 2000
“Napster is robbing me blind.”—Chris Robinson of the Black Crowes Salon Mar. 25, 2000
“It pisses me off and I resent it. I spent $15,000 on my Web site. I paid a publicist for a year and a half out of my own pocket. And now some kid's going to tell me my catalog should be free? They're just entrepreneurs setting themselves up to make a ton of money off other people's work. Where's the compensation for the artists? I know people using Napster are chuckling about kicking big, bad record labels. But as evil as the record companies may be, at least they're paying for your recording budget, and at least they're promoting you, and paying for tour support. We can make a new model—yeah right. It's laughable. Those people have no idea how the music business works. Because unless you're Alanis Morissette or Dave Matthews, you're not making money on the road. It's all I can do to break even on tour. And the only reason to tour is to promote the sale of my CD.”—Jonatha Brook Salon Mar. 25, 2000
“Our label is behind us from the start. They work hard for every nickel they make off us. They deserve to be paid. It's a no brainer. If it's not scanned, then the label at the end of the year says so long, and all of a sudden our careers are over, and I'm back at McDonald's.”—Morgan Rose, Sevendust Salon Mar. 25, 2000
“If Napster had our best interest in mind then they would ask our artists. Nobody at Napster has ever called to ask our permission. Artists say ‘Ask me.’ Explain what it is and ask if I want to participate. But Napster doesn't give them an opportunity. They're basically saying ‘fuck the workers.’ Let them work their asses off and we'll give it away for nothing. The bigger the lie the more you get away with, I suppose. There's no question Napster's going to lose in court. The only question is how much money in damages they'll have to pay. I hope it's enormous because then the big money investors, which Napster needs, will walk away.”—Cliff Burnstein, Q Prime Management (represents Red Hot Chili Peppers and Metallica) Salon Mar. 25, 2000 “Investors are going to realize it's a theft business and ask, how does it make money? It doesn't. It's all very well to say music should be free, but the reality is if you don't pay the artists, the road crew, the musicians, the recording studio, if there's no money in music, there's not going to be much music left. How many people would be doctors is they had to work for free? What if we said, ‘Hey, the airlines are ripping us off and we don't want to pay for tickets, we'll just steal them.’ Guess how long the airlines would last? If it becomes free, then it becomes extinct.”—Miles Copeland (manager for Sting) Salon Mar. 25, 2000
“I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”
—Sean “Puffy” Combs, CEO, Bad Boy Entertainment, Inc.
“Dixie Chicks and Senior Management are huge fans of the Internet and its possibilities. While there are great efforts being made to ensure that the rights of the artists and songwriters are protected, Napster's apparent way of doing business sets those efforts way back. If the Internet thieves are not stopped or better regulated, it not only robs current artists but might have even more serious repercussions for the next batch of artists. I support and applaud the RIAA on their efforts to make sure that Internet companies are not stealing the rights of the people who make the music.”
—Simon Renshaw, Senior Management (personal manager of the Dixie Chicks)
“Copying and distributing music illegally is the ultimate discrimination. It sends a message to our neighbors who create musical art that what they do, who they are, is not important enough. Does it matter? I can think of several stories where the rights of a particular group of people were deemed unimportant. None of them have a happy ending. Therefore, I strongly urge the operators of NAPSTER to use their technological acumen to bring an end to the trafficking of pirated musical works.”—Frank Breeden, President, Gospel Music Association, Inc.
“With the increasing accessibility of music on the Internet, and the new technology available on it, there must be a matching increase in responsibility. Without public accountability, this responsibility reverts to groups like the RIAA to seek out those who are misusing the advances in technology and to the courts to adapt and enforce the law. Napster is allowing people to disregard copyright laws because they were not written in the spirit of today's technology. These copyright laws are the only things that protect what musicians do for a living; write songs. Napster is allowing people to steal these songs.”—Jeff Cameron, Jeff Hanson Management & Promotions (represents Creed and other artists)
“Napster is undermining the efforts of creators and innovators of all kinds who are at the forefront of the electronic marketplace.”—Robert Holleyman, President and CEO, Business Software Alliance
From: http://www.riaa.com/about/artists/guotes.asp

The present invention seeks to serve the artist in a manner that artists long for, as suggested by the all of the posts above. By offering a full suite of tools for watermarking, thumbnailing, and rights definitions, as well as embedding advertising within and around content, and affording creators the ability to sell their work, 22nets provides a superior system over the prior art. Furthermore, by offering artists, producers, creators, and aggregators the opportunity to create and build social networks, wherein salable content is wed to the network and creators are afforded profits on a tiered basis, the present invention encourages and affords novel business models hitherto unknown. Enhanced manners of capitializing and profiting from one's creations are provided by the present invention, alongside enhanced method of protecting one's creations.

Furthermore, while itunes protects artist's downloads with DRM, itunes, as an instrument primarily for the major labels, fails to compensate the artist as well as an artist could compensate themselves. DRM ought to be free or close to free, as it is fundamentally a set of mathematical algorithms which cannot be patented any more than E=mcˆ2 can.
Regarding the shortcomings of iTunes, downhillbattle reports in Itunes is Bogus: http://www.downhillbattle.org/itunes/
People are paying for songs on the iTunes Music Store because they think it's a good way to support musicians. But iTunes misses a huge opportunity. Instead of creating a system that gets virtually all of fans' money directly to artists—finally possible with the internet—iTunes takes a big step backwards. Apple calls iTunes “revolutionary” but record companies are using the service to force the same exploitive and unfair business model onto a new medium.
It's too expensive
Let's start simple: the iTunes Music Store is not a good value for customers. Apple says many users are buying whole “albums” for $8-$12 each. That's less than the $16 store price, but used CDs at Amazon or ebay cost $5, and those come with liner notes. If you don't care about liner notes, you can burn the CD from a friend for 25 cents and send the musician a buck. In both cases, you end up with a real CD, and you can always use iTunes to rip it onto your computer or mp3 player. And you don't have to deal with restrictions on how you use it.
Lossy.
Lossy means loss
iTunes AAC files don't sound as good as CDs. AAC is a “lossy” compression format: it shrinks the sound file by throwing away subtle nuance and texture that a computer program thinks you won't be able to hear. The thing is, you can hear it. You might not notice listening to your iPod on the subway, but if you get home, lie back on the couch, and listen to your new iTunes album on a real stereo, it won't have the same nuance, punch, and presence that a CD has. A burned copy of a real CD will always sound better than a burned iTunes album.
“But I don't really care about compression”
Then you're in good company: lots of people just want to hear the songs they like and don't mind listening to compressed music. The majority of those people (the sensible ones) choose peer to peer filesharing programs like Kazaa or Acquisition to get their mp3 s. Downloads are fast, there's a bigger selection, and peer to peer sharing doesn't prop up the music industry. Plus it's free.
If you build a shiny new house on a landfill it still stinks
Apple says iTunes is “better than free” because it's “fair to the artists and record labels.” That's simply not true. First of all, Apple gets 3 times as much money as musicians from each sale. Apple takes a 35% cut from every song and every album sold, a huge amount considering how little they have to do. Record labels receive the other 65% of each sale. Of this, major label artists will end up with only 8 to 14 cents per song, depending on their contract. Many of them will never Artists Get Ripped Off. even see this paltry share because they have to pay for producers and recording costs, both of which can be enormous. Until the musician “recoups” these costs, when you buy an iTunes song, the label gives them nothing. (Sources: major label musician's cut Apple's cut For a thorough explanation of how recouping screws musicians, see Confessions of a Record Producer by Moses Avalon)
Nothing changed
So why does iTunes give artists such a raw deal? Because it's the exact same deal that artists have always gotten from the big five record companies. Despite huge new efficiencies created by internet distribution—no CDs to make, no distributors to store and ship them, no CD stores to build and run—artists receive the same pathetic cut. That is the disaster of iTunes. Instead of using this new medium to empower musicians and their fans, it helps the record industry cartel perpetuate the exploitation. Apple might say it's not their fault: after all, they didn't write the unfair record contracts. But when Apple supports and profits from an obviously unfair system, while telling customers that it's “fair to the artists”, they are just as guilty. For years, Apple Computer has built a reputation for straightforward business. So
If Apple honestly believes that the iTunes system is fair for artists, we challenge them to display the artist's cut next to each song and let their customers decide:
From: http://www.downhillbattle.org/itunes/

The shortcomings of iTunes were reflected in this recent article about recording star Weird Al Yankovic, reported on throughout the internet, including places such as Slashdot
http://apple.slashdot.org/article.pl?sid=06/06/15/0030209&from=rss:
How iTunes Hurts Weird Al Posted by samzenpus on Wed Jun. 14, '06 10:35 PM from the eat-it dept. Johnny X writes “Weird Al Yankovic recently said he makes far less money when you buy from iTunes than when you buy an actual CD. This guy did the math and showed that Weird Al could be losing up to 85% of his record sales income due to the ‘weird’ ways the record companies compute digital sales. Are all artists getting the shaft like this?”—http://apple.slashdot.org/article.pl?sid=06/06/15/0030209&from=rss http://www.anotherblogger.com/2006/06/13/weird-al-and-a-messed-up-itunes-deal/
In an “Ask Al” feature on his website, Weird Al Yankovic answered a question as to whether he makes more money from a traditional CD sale, or from a song purchased on the iTunes Music Store. His answer (on this page, fourth question from the top) indicates he makes more money from an album sale than he does from a download.
That makes no sense (and Yankovic admits he's baffled as well). There are essentially no per-sale costs associated with a download . . . no physical packaging, no artwork, and no shipping or storage fees, yet as an artist he makes more money from the sale of an item which has all of those overhead costs. Is this an oddity or are most artists in the same situation? http://www.anotherblogger.com/2006/06/13/weird-al-and-a-messed-up-itunes-deal/

The present invention allows artists to circumvent traditional record label contracts and systems such as iTunes that generally rip them off. It is a great irony in that in the age of digital downloading, which circumvents the costs associated with manufacturing, burning, printing, packaging, shipping, warehousing, and retailing CDs, an artist such as Weird Al should actually profit less from a song old via download on the iTune service. The present invention provides an improved system wherein the artist keeps most of the profit.

Furthermore, 22nets allows creators to also extract the wealth inherent within the networks they create.
Web 2.0 Colonialism? In a session at the crowded Web 2.0 conference in San Francisco last October, Yahoo CEO Terry Semel said user-generated content “is of utmost importance” to his company—“A gigantic piece of what we do and ability to monetize.” In the last year, Yahoo launched a blog service, a “publishers' network” that places ads on users' sites, and bought the popular photo-sharing service Fickr. The portal profits from these services by selling ads to run alongside them or by charging subscription fees. It's revenues rose 47 percent last year to $5.26 billion . . . . Profiting from user-generated content is Web 2.0 Colonialism.—Red Herring, Paid Citizens, Web 2.0 Colonialism?, Volume 3, No. 06

It should be noted that nowhere does yahoo™ owned flickr™ allow users to watermark nor define the rights to their content. 22nets will allow users to define their rights and watermark their content.

Lulu.com is expensive, and though it has no up-front fees, it is the best deal for those planning on selling little or no books:
Young's vision for Lulu.com is interesting. But there are less costly ways for authors to get their books on the markets and sold to readers. At my retail consulting company, we've figured out a way to design and produce 250-page hardcover books with full-color covers for about $6 a copy-far less than Lulu's $20 estimate. All it takes are software programs like Microsoft Word and Adobe Photoshop, a freelance professional editor, and a book manufacturer. While the idea of printing books one at a time may have real value to some authors, the revenue generated for the author or the company using Lulu's model is so poor that writing and publishing a book doesn't seem worth the effort. George Whalin, San Marcos, Calif.—Business 2.0 Talk Back/Letters, July 2006

It should be noted that Lulu.com does not readily share with its users the better, less expensive ways to profit from their content—this missing information is to keep lulu users using lulu—it does not seek the best interests of its users, but rather the best interests of lulu. 22nets would share such information, and it would encourage authors to seek out the best deals from printers. Furthermore, lulu does not provide an easy manner for a user to export their content to other services. 22nets would let users export a package of their information via an rdf/rss/xml feed. Furthermore, Lulu does not provide simple way for a user to build a social network, invite other authors, and profit from sales within the network they create. In other words, Lulu does not allow creators to fully benefit from any social network that they create—they do not allow the user to extract the wealth inherent within their network as given by Metcalfe's law. Lulu again concerns itself with aggregating a vast collection of artists who make little or no profit, and where the owners of the lulu system make the serious money.
But, like Greg Yardley, I want to know “Where the money is?” If pubsub or other Broadband Mechanic's customers like Going On are going to be making cash (somehow) by aggregating my content, I want a piece of it. And I don't think that's paranoid, Biatch. That's called getting a paycheck for the value you bring to the table. I think the companies behind this are certainly aware of what's in it for them, if they can get a bunch of bloggers to start adding structure to posts. But, sales training always taught me to start with the value to the customer (and the distributor). In this case, someone like Myspace, Typepad or Blogger would be the distributor and the rest of us lowly users are the customer. How do they and we benefit? Peter Caputa,—http://worcester.typepad.com/pc4media/2005/12/structured_blog.html
Profiting off user-generated content is Web 2.0 colonialism . . . . Which is what irks me. Structured user-generated content, especially aggregated reviews, is very valuable. Case in point—the del.icio.us purchase. Since del.icio.us? functionality is easily replicable, the deal was all about the value of user-generated content. You'd think with content being worth so much, the Structured Blogging initiative would contain a way for the content providers to indicate, in a machine-readable fashion, just how they would like to be reimbursed for the commercial use of the content they're providing. Not so—at least not anywhere I can see.—yardley.ca, “Structured blogging as Web 2.0 colonialism,”—http://www.yardley.ca/blog/index.php/archives/2005/12/14/structured-blogging-as-web-20-colonialism/

The present invention offers a means for creators to break free of the web 2.0 colonialism so as to maximize the creator's profitability and distribution. 22nets offers a means for creators to manage their rights in the context of a social network, thusly empowering the creator as never before. Furthermore, 22nets fosters greater profitability for social networks utilizing the 22nets philosophy, as by empowering creators, 22nets creates a trusted brand and system which attracts creators of quality content. RINF.COM reports to the world,
http://www.rinf.com/columnists/news/myspacefox-artists-beware
Myspace/Fox can use ANYTHING of yours you post to your site [music, videos, photographs, art work, etc.]. This means they can alter it, edit it, sell it, etc. WITHOUT giving you credit
This has recently been brought to my attention . . . . You can find the content that is quoted below by clicking “terms” on the myspace homepage and scrolling down a bit. I.e. its taken directly from the terms of use, it's not some silly paranoid internet scare tactic.
In summation, myspace/fox can use ANYTHING of yours you post to your site [music, videos, photographs, art work, etc.]. This means they can alter it, edit it, sell it, etc. WITHOUT giving you credit, giving you royalties, basically without giving you jack shit. Please be aware of this and use caution when sharing your creative works on myspace. I love being an intermanet whore like the rest of you and I adore seeing everyone's new work—but I'd hate for it to be violated and taken out from under your control by a media company that's much bigger than you.
If you think this is as frightening as I do, please repost and warn your fellow artists/friends about this. Direct quote is below.
Proprietary Rights in Content on MySpace.com. By displaying or publishing (“posting”) any Content, messages, text, files, images, photos, video, sounds, profiles, works of authorship, or any other materials (collectively, “Content”) on or through the Services, you hereby grant to MySpace.com, a non-exclusive, fully-paid and royalty-free, worldwide license (with the right to sublicense through unlimited levels of sublicensees) to use, copy, modify, adapt, translate, publicly perform, publicly display, store, reproduce, transmit, and distribute such Content on and through the Services. This license will terminate at the time you remove such Content from the Services.
Notwithstanding the foregoing, a back-up or residual copy of the Content posted by you may remain on the MySpace.com servers after you have removed the Content from the Services, and MySpace.com retains the rights to those copies. You represent and warrant that: (i) you own the Content posted by you on or through the Services or otherwise have the right to grant the license set forth in this section, and (ii) the posting of your Content on or through the Services does not violate the privacy rights, publicity rights, copyrights, contract rights or any other rights of any person. You agree to pay for all royalties, fees, and any other monies owing any person by reason of any Content posted by you to or through the Services. http://www.rinf.com/columnists/news/myspacefox-artists-beware

Apparently myspace has since altered its terms of service, which they are perfectly free to alter again as they see fit. And still, myspace does not afford an artist the opportunity to utilize digital rights management—that would be the digital rights management that is utilized by leading services such as Apple's iTunes™, YAHOO!™ Music, or Napster, which sell the vast majority of successful, major artists including Guns and Roses, Liz Phair, The Ramones, Pink Floyd, and Johnny Cash. DRM is simple and virtually free, and it is a tragedy that rising artists have no simple access to it throughout the prior art. 22nets provides rising artists with DRM.

While myspace hosts tens of thousands of bands, myspace has not and will not create a Beatles, nor Rolling Stones, nor Johnny Cash. Myspace is a postmodern creation and thus has forgotten the ideals via which epic storytelling in art is born upon, as well as the ideals by which private property is protected, dating back to what Twain called “that original Decalogue”—the Bible, in which it says “thou shall not steal.” This is because Rupert Murdoch and myspace rely primarily upon a postmodem, deconstructed high-school atmosphere wherein popular teenage girls choose the hits, and the best way to become popular is to pose in one's underwear while mimicking the plethora of porn stars myspace is founded upon. Millions register with accounts to see the pictures, and Myspace takes the opportunity to hype storyless, plotless movies, music, and more.

So it is that myspace has traded traditional Constitutional Rights as well as the exalted moral norms found in the music of Johnny Cash and Bob Dylan to build a bustling mob of crap, where they can hype plotless, storyless productions such as the 2006 Superman bomb. Thus the Hamlets, Dantes, and Shakespeares of our day do not have a chance on myspace, as myspace lacks classic leadership and the spirit of the United States Constitution. Nor does an exalting renaissance have a chance on myspace, which history will show has been produced far more often by individuals than mobs of fatherless teenage girls in their underwear befriending Tucker Max. A further advantage of 22nets is that by respecting property rights more fundamentally than the web 2.0 denizens and experts, it can further a renaissance.

The present 22nets invention, by respecting fundamental property rights, and by affording artists and users the opportunity to profit from the networks they create, is far better suited to creating valuable and lasting culture, as well as business models centered around valuable and lasting culture, than is myspace™.

Not only does myspace™ fail to compensate their bands/users who are doing all the heavy lifting, but they fail to offer the bands more direct ways to profit from the social networks the bands/users build. The present invention's system allows bands to profit more directly and immediately off their social networks. Like most Web 2.0 companies, myspace was saved by google's adsense program. But there other revenue models that will work, and that will afford stand-alone social networks; and these novel revenue models begin with respecting the creators' rights and empowering the creators of content and builders of social networks, allowing them to extract the wealth inherent within the social networks they create.

The present invention—22nets—suggests a brand new way to profitability—let users aggregate and sell content in their social networks, and the owners of the 22nets system get a cut. The zdnet.com blog reports he following:
http://blogs.zdnet.com/micro-markets/index.php?p=364
MySpace branded friends strategy has not been sufficient, however, to mark the Fox acquisition a success. MySpace is now relying on Google for its financial viability, as I put forth in “Google: MySpace savior?”
‘In one fell swoop, we have paid for two-thirds of our Internet acquisitions,’ said Peter Chemin, President of News Corporation . . . (on) the multi-year deal for Google to be the exclusive search and keyword targeted advertising sales provider for Fox Interactive Media Web properties, including MySpace.com.
Listening to the joint conference call for financial analysts and press, however, the lack of enthusiasm for the $900 million deal was palpable. The profitability of MySpace was questioned, as well as the quality and salability of its advertising inventory.
By seeming to use the Google revenue share deal to ‘justify’ its billion dollar plus investments in Web properties, News Corp did not provide a ringing endorsement for the stand alone viability of its Internet sites. http://blogs.zdnet.com/micro-markets/index.php?p=364

As the above blog points out, without Google, myspace would not have a viable business model. What the above article does not point out is that the creators will receive none of the profits from the google ads. Murdoch does not have to pay teenage girls to upload pictures of themselves in their underwear, nor does he have to pay bands to upload their mp3's. Well, that will limit the quality of the content and the quality of the myspace brand.

The difficulty of developing a profitable, stand-alone social network is characterized in this following article/blog, which further supports the 22nets business model:
http://blogs.zdnet.com/micro-markets/?p=374
Is Web 2.0 starting to see green?
Posted by Donna Bogatin @ 7:01 pm
Digg This!
Web 2.0 under monetized, free-to-the-consumer services are hoping to start seeing green at the end of the tunnel.
Today, Facebook bit the bullet and outsourced its ad sales to Microsoft (see Facebook outsources ad sales to Microsoft: Why can't it make money on its own?)
Facebook, same as YouTube, MySpace, Digg . . . has been unable to fully monetize the large usage its free services engender.
In “Facebook cedes equity stake to ad agency and gains advertising dollars” last June, I discuss the Web 2.0 property's difficulties in gaining advertising revenues:
Advertising at Facebook is currently focused on low cost, local advertiser created ‘Facebook Flyers.’ Facebook says of its ‘Facebook Flyers’:
Your Flyer will be posted to the Facebook Flyer Board and advertised on other Facebook pages. For only $5, your Flyer will be displayed 2,500 times! At small schools, we will display your Flyer as many times as possible but cannot guarantee the number of views.
If the best Facebook can do on its own is $5 media placements, outsourcing ad sales to Microsoft is better than, literally nothing. Settling for perhaps 50-60 cents on the dollar, however, is not the best it could do.
Yesterday, YouTube “relaxed” its no “sellout to corporate interests” stance to launch a new, dedicated “YouTube Channel”: “The Official Paris Hilton YouTube Channel,” sponsored by Fox's “Prison Break,” as I describe in “YouTube nod to MySpace: Paris Hilton is YouTube's newest friend”:
dedicated promo tool designed to both foster sales of Paris Hilton records and boost viewership of Fox's PrisonBreak show. Accordingly, the “Channel” content is “commercials” for Paris Hilton records and the Fox PrisonBreak show. The clips are professionally produced, Hollywood style mainstream promos.
It is unclear, however, how lucrative YouTube's corporate branded channel strategy is.
YouTube announced a somewhat similar deal with NBC last June, but it is a cross-promotional one where “little money changes hands,” according to Associated Press reports:
Under the deal, YouTube will create a separate channel for NBC video, so that visitors can easily pull up the half-dozen or more items that NBC plans to offer at any given time. It will be similar to channels that other companies, filmmakers and everyday users create.
NBC will sponsor a contest in which fans of ‘The Office’ can create their own 20-second promotional clip—as long as they don't use any copyright footage from the show. NBC will provide music, graphics and a ‘how-to’ video.
Little money will change hands, although NBC commits to buying an undisclosed amount of ads on YouTube. NBC will also run spots on television publicizing the contest.
NBC and YouTube officials acknowledged the possibility that fans will reject the clips if they appear simply as promotions, but YouTube co-founder Chad Hurley said fans would likely embrace the video if it is compelling and not available anywhere else.
YouTube and Facebook may not be implementing optimal monetization strategies, but at least they are beginning to realize that the best of Web 2.0 is not really free.
After all, for how long could YouTube ignore its estimated $1 million monthly bandwidth bill when it has “only” banked $11.5 million in VC money to fund its free-to-the-consumer video hosting Web site?
Surprisingly, however, many in the industry still believe the best of Web 2.0 can, and should be, free.
For example, my colleague, Dana Blankenhorn, says today in “The Internet Business Model”:
The way to success on the Internet is to get something out there, then convince people to try it, free . . . the idea that success is defined by users, not buyers, has become an accepted part of business life.
This is possible because on the Internet the nominal cost of serving new users is virtually zero until you scale to a point where profits are possible merely from the size of your audience.
ZDNet commenter Anton Philidor notes, succinctly, however:
The discovery of the dot bomb era . . . was You cannot give away your main product for free and survive.
Indeed. As the size of the free user base increases, total infrastructure costs increase as well, although per-user costs decrease. As for scaling “to a point where profits are possible merely from the size of your audience,” Web 2.0 properties may be generous, but they are not financial magicians.
As some have noted, however, my point of view is skewed by the rigorous financial analysis required of an Investment Banker, not “Web 2.0 dreaming” (see “Web 2.0 dreaming: get rich quick, or fail trying”) http://blogs.zdnet.com/micro-markets/?p=374
Charliefrog77.com reports: http://www.charliefrog77.com/2005/12/why-does-myspace-suck-for-indie-bands.asp
Sunday, Dec. 4, 2005
Why Does Myspace Suck For Indie Bands?
Anything you post on MySpace becomes the property of MySpace. Did you know that?
By posting Content on any public area of MySpace.com, you automatically grant as well as represent and warrant that you have the right to grant to MySpace.com, an irrevocable, perpetual, non-exclusive, fully paid, worldwide license to use, copy, perform, display, and distribute such information and content to MySpace.com and that MySpace.com has the right to prepare derivative works of, or incorporate into other works, such information and content, and to grant and authorize sublicenses of the foregoing.
Did you hear that? Your stuff becomes the property of MySpace when you post it on MySpace. Here are the terms they use to describe the property you give to them:
Irrevocable: You can't take it back. You can't say “hey, waitaminute.” Your stuff is their stuff, and you don't get the rights to it.
Perpetual: That means forever. Your stuff is there stuff, forever.
Non-exclusive: Here's a faint glimmer of hope—they let you publish your stuff somewhere else if you want.
Fully paid: That means you aren't entitled to anything if MySpace wants to sell your music for a profit.
Worldwide: MySpace can sell millions of dollars worth of your music in Japan. And you don't get any royalties.
Copy: They can do anything they want with your music.
Perform: They can play it anywhere they want.
Display: They can put your photos up anywhere they want.
Prepare Derivative Works: They can use your media in their own media, selling things based on your music, without you ever getting a penny from it.
Incorporate Into Other Works: They can totally take your songs and set them to different tunes, selling them without you receiving any form of compensation whatsoever.
I'm inclined to believe that if you publish a song on MySpace, and that song makes you a million dollars one day, MySpace can legally sue you for damages. Here's a scary thing: MySpace is allowed to “authorize sublicenses of the foregoing”, meaning that they are allowed to license your music for sale by other companies. That means THEY get the royalties from your music, and not you.

Isn't that nice?
HTTP://WWW.CHARLIEFROG77.COM/2005/12/WHY-DOES-MYSPACE-SUCK-FOR-INDIE-BANDS.ASP

While Myspace has altered their terms, they remain free to alter them again. Revver.com only allows users to use Creative Commons Licenses, thusly giving up control of their content and placing it in the public domain. And Youtube, another web 2.0 company, follows the standard web 2.0 protocol—the creator has little or no rights—certainly less rights than what the Constitution provides. Are web 2.0 companies any different from record companies when it comes to screwing large numbers of creators so as to provide profits for the elite insiders? Boing Boing reports:
http://www.boingboing.net/2006/07/20/youtubes_new_policy_.html
The newly revised Terms and Conditions page at YouTube raises important questions for anyone who uploads videos there. Eliot Van Buskirk at the Wired News music blog “Listening Post” writes:
Musicians such as Billy Bragg have been complaining about networking/music site MySpace's terms of use—and rightfully so. MySpace is said to be changing its tune, and should be posting updated terms soon (currently, its About page is offline). The video site YouTube constitutes an equal or larger threat to small content producers. Before you upload that video of your 19-person indie rocker reggae band, for instance, you may want to read the fine print. YouTube's “new” Terms & Conditions allow them to sell whatever you uploaded however they want:
“ . . . by submitting the User Submissions to YouTube, you hereby grant YouTube a worldwide, non-exclusive, royalty-free, sublicenseable and transferable license to use, reproduce, distribute, prepare derivative works of, display, and perform the User Submissions in connection with the YouTube Website and YouTube's (and its successor's) business . . . in any media formats and through any media channels.”
Among other things, this means they could strip the audio portion of any track and sell it on a CD. Or, they could sell your video to an ad firm looking to get “edgy”; suddenly your indie reggae tune could be the soundtrack to a new ad for SUVs. The sky's still the limit, when it comes to the rights you surrender to YouTube when you upload your video. Perhaps even scarier is the idea that anyone who might eventually buy YouTube would automatically obtain these same rights. Since YouTube is so popular, with 100 million videos shown each day, it's an attractive acquisition target for any number of companies.
—From http://www.boingboing.net/2006/07/20/youtubes_new_policy_.html

### OBJECTS AND ADVANTAGES

The present invention is novel in that it believes that by providing users enhanced means to protect and profit form their content and the social networks they create, not only will users profit more, but the system as a whole will profit more. With the present invention described herein, existing social networks and content archives such as myspace™ and youtube™ and revver™ could vastly raise their bottom line while creating novel business models. Because the United States allows everyone to own their own property—both land and ideas—the United States is the world's richest country, and that same exalted spirit is at the center and circumference of the present invention.

22nets provides a way to achieve the long sought-after profitability in social networks—the key is marrying social networks to content, both that which is created by the individuals in the social network, as well as content and merchandise that exists beyond. Let every user upload content of their own, define rights, and sell songs, photography, and art. Groups of mutually-attracted users will form, providing organic brands for fashion, photography, and more. Creators will benefit as their content is bought and sold in these new marketplace; users will benefit as the abundance of content on the web is filtered to suit their tastes; and aggregators and producers will benefit as they are afforded new places to launch their brands and aggregate content quickly and easily, as well as profit from it. And last, but not least, the owner of such a social networking ecommerce system as described within this patent will benefit greatly—for any system which empowers creators will empower the owner of said system.

By providing creators with a full spectrum of digital rights management (DRM) options, 22nets allows the creators to first of all upload their content and define their rights, unlike flickr™ or myspace™ or youtube™ or revver™ or any other current content aggregating or social networking system found in the current or prior art. Flickr™ does not even allow users to watermark their work—even though the watermarking code would take an afternoon for one of their programmers to implement, as it is already part of the php language and libraries. This feature is not included in flickr™, nor myspace™, nor youtube™, nor facebook™, as watermarking would allow for the user to celebrate and promote their own brand, which would cut into flickr/myspace/youtube's brand.

### MORE PRIOR ART

As patent 6,175,831 states, the concept of networking is as old as politics. Social networking has taken off on the internet, and commercial networking can be every bit as successful. As all content tends towards the digital, tomorrow's record labels, movie distribution systems, and stock photography shops can benefit from a networked model wherein self-selecting groups of creators define leading brands.

The present 22nets invention believes that the key to creating profitable social networks is to allow the participants to participate more fully in any profitability. However, basing a user's profitability on pageviews generated, people recruited, or monetary incentives may degrade the network by encouraging users to spam. A better way is to marry a network of users to a network of creative content that users may add to, as well as buy and sell, thusly providing a system where users only succeed when creating a trusted, aesthetically pleasing brand for their group's network.

A key to the present invention is providing users with freedom—freedom to define the rights of their content, freedom to associate with other members, and freedom to add content to their storefront.

The present invention sees a way to achieve the profitability that has generally remained elusive for social networks, as reported in many places including here: http://socialtwister.com/archives/000112.html
As the venture capitalists pour more and more money into the ever-expanding crop of Social Networking applications and service providers, many outsiders are wondering if we're re-living the bubble—thinking of the 90s. As these discussions progress, more and more individuals are starting to examine the potential revenue models and viability of such solutions . . . . What will be the winning model? Is it viable at all? Opinions vary, to say the least.—http://socialtwister.com/archives/000112.html
“With yesterday's news that Friendster is laying off people and that the company's CEO will be leaving in a few weeks, it's apparent that some of the first generation social networking sites are hitting a few bumps in the road. Bill Burnham wrote about this problem in a great post a few weeks ago, “You see, despite all the hype about social networking, it has now become readily apparent that social networking is not an application in and of itself, but rather a by-product of other activities.” “In other words, there needs to be a reason why people are getting connected. Jeff Clavier continues along that mode of thinking, “The first generation of social networking sites (Friendster, Tribe, ZeroDegrees, Orkut, . . . ) have all gone through ups and downs (more downs) as they were pioneering in this new space—and not really figuring out a business model for themselves, besides advertising. Social networking is now an integral part of the fabric of Internet applications, but offers limited value in its own right—with a very quick decay of one's interest.” “I would argue that in addition to possessing a reason d'etre, successful social networking companies will more closely integrate the revenue model into the functionality of the service. It's not just about throwing up some advertising. Take, for example, H3, which embeds the purpose of the network (locating job candidates) directly into the revenue stream (a bounty for a located candidate). I think that we'll continue to see closer alignment of the connections' goals with the revenue derived from them.”—http://www.genuinevc.com/archives/2005/05/social_networki.htm

The focus of this invention, 22nets, is not so much on the technology underlying the social network, which has been done and modified in many ways and which can be found throughout many patent applications and which can easily be built by anyone skilled in the art of advanced web development, but rather this invention focuses on the unique emergence of branded, high-quality content archives and marketplaces that will emerge when content archives and marketplaces are married to social networking systems. The novel technology of the present invention is the marriage of salable content to the social network. Further novel technology of the present invention is offering a full spectrum of digital rights management to the user when they upload their content, and the offering of digital rights management, while not necessary to the novelty of the present invention, further enhances the value of the present invention.

### MORE PRIOT ART

There exists extensive prior art in this crowded field of content distribution on the net.

Open Source does not seem the proper way to approach digital rights management on the WWW, as the open source community is generally opposed to digital rights management, and it would be difficult to motivate and attract programmers that would make digital rights management as successful as MYSQL, Linux, and PHP/Perl/Python/Ruby. Also, open source tends to be better-suited to large-scale projects such as LAMP than narrower applications such as word processing and film editing, where proprietary solutions forge ahead and dominate the market. For this reason, prior art in the realm of Open Source Digital Rights Management, including that found within the present inventor Dr Elliot McGucken's research presented at the 2003 OSCOM hosted at the Harvard Law School (oscom.org, authena.org), is not well-suited to accomplishing the objectives of the present invention and affording the novel business models described herein.

U.S. Pat. No. 6,175,831 by Weinreich et al and assigned to Six Degrees, Inc states, “As realized by the present applicants, these prior art systems do not provide any mechanism whereby one user can take advantage of the database comprised of the authorized users of e-mail systems for personal and/or professional gain. As also realized by the inventors, if an individual can register with the database, for example, by providing professional and personal data, and perhaps other selected criteria common to all (or significant numbers of the users), the user consequently can be linked to a plurality of other such individuals who have similarly provided information based on defined linking relationships.”

Friendster™, LinkedIn™, Facebook™, Myspace™ and Tribe.net™ all support the networking of individuals.
U.S. Pat. No. 6,175,831 by Weinreich et al and assigned to Six Degrees, Inc states, “Individuals are mutually linked upon mutual approval, and linked individuals are linked to other individuals that are linked to individuals they are linked with.” U.S. Pat. No. 6,175,831 by Weinreich et al and assigned to Six Degrees, Inc

### FURTHER OBJECTS AND ADVANTAGES

This invention goes beyond the prior art in providing a means of associating content with individuals, be they creators, browsers, or aggregators. Thus the network takes on a whole new meaning as not only can individuals benefit from mutual linking, but brand new marketplaces of linked content emerge. The end result of this invention, hitherto unseen in other social networking patents and manifestations, is marketplaces created by self-selecting creators and viewers. This invention rises above and beyond the prior art by supporting the networking of content in a relational database. Novel content marketplaces based upon mutually-approved relationships in a social network are a novel emergent feature of this present invention.

None of the prior art characterizes the unique emergent properties of marrying the social networking paradigm to the content creation business.
For instance, in U.S. patent application No. 20050154639, Karl Douglas writes, “This invention creates an enhanced marketing system for Online Auctions and ECommerce websites to further provide secondary reasons for current Members to be active with the website. It also provides for the acquisition, activation and retention of new Members that may come to them by way of the 3.sup.rd party Organizations that currently have a membership they can influence to become active with the Online Auction website. This invention provides for the presence of an accounting system for awarded incentive points, accessibility to that accounting system and the distribution of those points either through direct redemptions, transfer to other Members or transfer to 3.sup.rd party Organizations.”

Nowhere in the patent application No. 20050154639 does Karl Douglas mention the emergent advantages of marrying the social networking paradigm to the creative-arts business. Individual creators face an uphill battle in creating an audience, and individual consumers face an uphill battle in finding quality indie content upon the vast internet. By marrying the paradigm of social networking to ecommerce presences supporting the arts, self-selecting groups of artists can form their own brands, thusly helping consumers find preferred content. Nowhere in any patent or patent application does it mention the emergent advantages of marrying the social networking paradigm to the creative arts businesses.

Nowhere in the prior art does it suggest that content marketplaces should be combined with social networks.

This invention is none-obvious for the above reasons and more.

### FURTHER PRIOT ART

While Lulu has Lulu groups, it lets anyone join them. Furthermore, Lulu provides no way for one group to inherit members from a different group.

The present invention allows a photography shop to inherit previous members, and it also allows groups to accept or reject potential members, as well as their content.

The lulu.com website writes:
“How do I join a Lulu group? You can join a recommended group by clicking the JOIN GROUP button in the Groups you might find interesting section of the My Groups page. If you don't have any recommended groups, you can 1. Use the Search Groups box on your My Groups page or click the View all groups link to find a group that interests you. 2. Click on a group in the search results to view its homepage and learn more about it. 3. Click the JOIN THIS GROUP button on the group homepage to join the group.”

Though you might start, join, and build a group, there seems no way to profit form the content sold within that group. The profiting from the social interaction is primarily kept by lulu.

Friendster, though armed with a prominent patent on social networking, has so far failed to realize profitability.
“Restructuring At Friendster: friendster logo According to this post by Jeremy Zawodny, some big changes ahead at social networking site Friendster. CEO Scott Sassa might be out, layoffs and more VC funding. If he is out, it is a huge public failing of their supposed Hollywood/media/social networking nexus they thought they could use and develop a business model around.
Update: Rob Hof at Business Week has confirmed Jeremy's report and then some: Scott Sassa is out as president and CEO, replaced by Taek Kwon, evp-product and technology at Citysearch.com. Also, Friendster laid off five people from its 55-person staff. Friendster spokesperson Carleen LeVasseur told Hof that Sassa led Friendster to profitability but that the company decided to emphasize software development to enhance the user experience—Kwon's expertise. From Hof: “I don't think it's hopeless. But man, it's tough to restore lost cool, and I'm not sure even the whizziest technology will do the trick.”
Jeff Clavier: “Social networking is now an integral part of the fabric of Internet applications, but offers limited value in its own right—with a very quick decay of one's interest.”
<http://www.paidcontent.org/pc/arch/2005_{—}05_{—}24.shtml#013937>
http://www.genuinevc.com/archives/2005/05/social_networki.htm
Social Networking for a Reason (and Revenue)
“With’ yesterdays news (http://www.businessweek.com/the_thread/techbeat/archives/2005/05/layoffs_at_frie.html?campaign_id=rss_blog_techbeat) that Friendster™ is laying off people and that the company's CEO will be leaving in a few weeks, it's apparent that some of the first generation social networking sites are hitting a few bumps in the road. Bill Burnham wrote about this problem in a great post (http://www.billburnham.blogs.com/burnhamsbeat/2005/03/earth_to_friend.html) a few weeks ago, “You see, despite all the hype about social networking, it has now become readily apparent that social networking is not an application in and of itself, but rather a by-product of other activities.” In other words, there needs to be a reason why people are getting connected. Jeff Clavier continues (http://blog.softtechvc.com/2005/05/layoffs_at_frie.html) along that mode of thinking, “The first generation of social networking sites (Friendster, Tribe, ZeroDegrees, Orkut, . . . ) have all gone through ups and downs (more downs) as they were pioneering in this new space—and not really figuring out a business model for themselves, besides advertising. Social networking is now an integral part of the fabric of Internet applications, but offers limited value in its own right—with a very quick decay of one's interest.”
I would argue that in addition to possessing a reason d'etre, successful social networking companies will more closely integrate the revenue model into the functionality of the service. It's not just about throwing up some advertising. Take, for example, H3 <http://h3.com/>, which embeds the purpose of the network (locating job candidates) directly into the revenue stream (a bounty for a located candidate). I think that we'll continue to see closer alignment of the connections' goals with the revenue derived from them.—from http://www.genuinevc.com/archives/2005/05/social_networki.htm

### FURTHER PRIOR ART: YAHOO!

“Abstract: A method, apparatus, and system are directed towards managing a view of a social network user's personal information based, in part, on user-defined criteria. The user-defined criteria may be applied towards a user's relationship with each prospective viewer. The user-defined criteria may include degrees of separation between members of the social network, a relationship to the prospective viewer, as well as criteria based, in part, on activities, such as dating, employment, hobbies, and the like. The user-defined criteria may also be based on a group membership, a strength of a relationship, and the like. Such user-defined relationship criteria may then be mapped against various categories of information associated with social network user to provide customized views of the social network user.”

In patent application #20050177385, Yahoo! Inc. writes:

In the above description concerning the latest iteration of social networking, yahoo does not mention that content marketplaces and archives could emerge if the social networking paradigm were married to content, specifically said content being created by creators in the social network. This present invention promotes such marketplaces and archives which reside upon networked creators and views of content. As the content marketplaces and archives that are afforded by the present invention could provide a revenue stream, a long-sought-after solution to the unprofitability of social networking services could be realized.

Yahoo's patent goes on to state,

### FIELD OF THE INVENTION

“[0001] The present invention relates generally to computing software for managing a social network view, and more particularly to a method and system for customizing views of a social network user.”

In the above description concerning the latest iteration of social networking, yahoo does not mention that content marketplaces and archives could emerge if the social networking paradigm were married to content, specifically said content being created by creators in the social network. This present invention promotes such marketplaces and archives which reside upon networked creators and views of content. As the content marketplaces and archives that are afforded by the present invention could provide a revenue stream, a long-sought-after solution to the unprofitability of social networking services could be realized.
“[0002] Social networking includes a concept that an individual's online personal network of friends, family colleagues, coworkers, and the subsequent connections within those networks, can be utilized to find more relevant connections for dating, job networking, service referrals, activity partners, and the like. Because individuals are more likely to trust and value the opinions from people they know than from complete strangers, social networking is typically directed towards mining these network relationships in a way that is often more difficult to do offline.”

While yahoo notes that “an individual's online personal network of friends, family colleagues, coworkers, and the subsequent connections within those networks, can be utilized to find more relevant connections for dating, job networking, service referrals, activity partners, and the like,” yahoo does not mention that branded content archives and marketplaces could emerge were personal networks married to content, both content created by the participants in the network, and others.
Yahoo's patent continues, “[0003] Thus, there has been a flurry of companies launching services that help people to build and mine their personal networks. However, these efforts have been predominately directed towards dating and job opportunities. Many of these companies are struggling with developing additional services that will build customer loyalty. Without the ability to extend the value of the existing networks, social networking loses its appeal. Thus, there is a need in the industry for better mechanisms to manage, mine, and cultivate personal networks. Therefore, it is with respect to these considerations and others that the present invention has been made.”

In the above description concerning the latest iteration of social networking, yahoo knocks the prior art by saying, “Many of these companies are struggling with developing additional services that will build customer loyalty. Without the ability to extend the value of the existing networks, social networking loses its appeal.

Yahoo does not mention nor propose that a way to extend the value of the existing networks would be to marry the networks to content archives and marketplaces. Yahoo sates, “Thus, there is a need in the industry for better mechanisms to manage, mine, and cultivate personal networks. Therefore, it is with respect to these considerations and others that the present invention has been made.”

Yahoo acknowledges the need for social networking mechanisms to evolve towards greater usefulness and profitability, but nowhere does yahoo, nor any other prior art mention that content marketplaces and archives could emerge if the social networking paradigm were married to content, both content created by creators in the social network, and content created by those beyond the network. This present invention promotes such marketplaces and archives which reside upon networked creators and views of content. As the content marketplaces and archives that are afforded by the present invention could provide a revenue stream, a long-sought-after solution to the general unprofitability of social networking services could be realized.

Furthermore, nowhere in the prior art does it mention a tiered commission system for a network of creators selling content belonging to themselves and other creators in the context of a social network or content archive, whereby creators are compensated in proportion to the degrees to which they or their groups are separated.

### FURTHER PRIOR ART: MPERIA

Mperia offers a further example of prior art over which the present invention offers improved and superior aspects.
http://rocknerd.org/article. pl?sid=04/03/13/010243 &mode=thread&tid=7&tid=29 “Johnny Wong <mailto:johnny@bitpass.com> writes: An online music store set to debut this spring will be the first to combine a distribution channel for independent musicians with a social networking platform for their fans.”<http://rocknerd.org/article.pl?sid=04/03/13/010243&mode=thread&tid=7&tid=29>

What mperia misses is the vast potential of allowing social networking between recording artists and labels, in addition to fans.
http://www.mperia.com/news.php?id=52: Mperia also combines everything students (and beyond) love about social networking sites with the needs of indie music—think of the Facebook, except all your friends are either artists or other users who have the same music tastes as you. The community provides a way for the 18,000 artists on Mperia to somehow get sifted through.
“(Independent artists) don't have a name, so you've got to find them out through social networks,” Gravengaard says of the additional function to the Mperia site. “You get a little exposure to an artist you've never heard of that you might like because your friend likes them.”
“The site has been available publicly since February, and already certain genres of music have exploded, particularly goth industrial, Gravengaard says. One artist, Curiosity, an industrial jazz pianist who is a third-year student at DePaul University, has enjoyed the success of finding new fans.”<http://www.mperia.com/news.php?id=52>

22net's Advantages: What mperia doesn't do is allow artists to combine into networks and offer commercial storefronts where all the network's goods are sold. Also, mperia doesn't allow hybrid interaction between fashion designers, artists, musicians, and others. Furthermore, mperia doesn't allow users to form a group, invite artists to join, and then profit from sales of that group. Thus mperia doesn't realize the full commercial potential of a social network married to creative content that would allow a visionary music connoisseur to join the network, establish a new group, recruit bands, promote said bands, and form a virtual record label. Nor does mperia allow a band to recruit fellow bands to a group and then receive commissions when songs are sold from the storefront of said group.

This present invention realizes the true, deeper beauty of the social networking paradigm—the emergent marketplaces and archives that would enrich the individuals who found and build them, as well as the consumers who shop within them.

Building a quality network takes time, talent, and effort, and the builders of those networks should be rewarded. Furthermore, if the builders of high-quality networks are rewarded, they will be inspired to build even better networks.

This invention, by providing incentives—both aesthetic and monetary—to those who build high-quality networks, be they creators, aggregators, or viewers of content, adds overall commercial value to the social networking paradigm. It 1) ensures higher-quality networks, 2) allows users to benefit from their networking skills and work, and 3) provides consumers with trusted archives and marketplaces for creative works.

### MORE PRIOR ART

The altnet.com website reports:
Altnet is the leading online distributor of licensed digital content. We provide the means for record labels, film studios and software developers to market and sell their products to a worldwide audience of 70 million users. Altnet distributes licensed content into leading peer-to-peer applications and internet web sites, providing their users with access to Altnet's library of Digital Rights Managed content and payment processing platform.

Upon further inspection of the altnet site and service, there exists no obvious place to upload one's content. There exists no drop-down menus where one may define one's rights. A creator cannot choose the creative commons licenses, as they are not offered. There is nowhere to add friends, and opportunities for social networking are not provided by altnet.com. There are no opportunities to add advertising, nor profit from advertising tied to one's media. DRM is far from free on the altnet site. It in fact costs quite a bit. The latent site states: http://www.altnet.com/support/faq.asp: Questions for Content Owners
Creating and managing my campaigns. How can Altnet help me? How much does it cost? How much will it cost to get started? You can create your own campaigns from us little as $99 for one file or $199 for three files—head over to www.altnet.com/contentPromotion to find out more and get started now!

$99 per file or $199 for three! This means that if an indie artist wanted to upload an album of twelve songs, it would cost $796 !

By giving Microsoft DRM away for free or a far reduced price—the same DRM altnet uses—the present invention offers musicians, filmmakers, and other artists a superior deal than does the prior art and altnet. For instance, EZDRM offers thousands of Microsoft DRM licenses for a few dollars a month. By offering creators, filmmakers, artists, and others the opportunity to use creative commons licenses, the present invention offers creators and producers a superior deal over that offered via prior art. By offering creators, filmmakers, artists, and others the ability to participate in and build networks, the present invention offers superior commercial opportunities and means for making money than does the prior art. By providing a tiered compensation structure tied to the underlying social network, the present invention motivates content creators to build better networks, by providing them with monetary rewards proportional to the size and quantity of the networks, both content and social, that they create.

The Altnet site says:
http://www.altnet.com/contentPromotion/
“MAXIMIZE ROI—With Altnet, you only pay for results. * Altnet is RISK FREE and COST EFFECTIVE, utilizing the well proven pay-for-performance model * You pay only when someone actually clicks and downloads your content * Altnet offers much lower CPCs (cost-per-clicks) than the competition”

To the right of this it says,
Promote and sell. Sign up and get started for just $99! Sign Up Now!
From: http://www.altnet.com/contentPromotion/

So it is that Altnet seems confused—to first of all say that you only pay when someone downloads your content, and then to say that you must first pony up $99. But the fact is that before one realizes any results, one has to pay at least $99. So it is that the DRM costs are exorbitant, and thus the vast majority of indie bands and creators have little or no use for altnet, further limiting the reach and popularity of the network and the brand.

### FURTHER OBJECTS AND ADVANTAGES

Accordingly, besides the objects and advantages of the social network married to content archives and ecommerce capabilities described in the above sections, several objects and advantages of the present invention are:

a) Novelty of Invention

There exist numerous social networks such as friendster.com, myspace.com, tribes.net, orkut.com, and others. There exist numerous ecommerce sites for content such as itunes.com, amazon.com, lulu.com, and deviantart.com, and others.

The present invention combines the two preceding paradigms—the social network and the content marketplace—in a novel manner, offering a novel means for growing hitherto unseen ventures in the arts and ecommerce.

This invention offers a novel, unobvious method for achieving profitability through social networks, by marrying social networks to archives and marketplaces of content.

More particularly, this invention offers a novel, unobvious method for achieving profitability through social networks, by marrying social networks to archives and marketplaces of content created by participants in said social networks.

Social networking sites foster the growth of “trusted” networks of groups of individuals. But, as Jeff Clavier writes at http://www.genuinevc.com/archives/2005/05/social_networki.htm:
“Social networking is now an integral part of the fabric of Internet applications, but offers limited value in its own right—with a very quick decay of one's interest.”—http://www.genuinevc.com/archives/2005/05/social_networki.htm Ecommerce sites foster the sale and delivery of goods, both online and offline.

This invention will achieve a profitable business model by offering trusted networks, marketplaces, and archives of creative goods, including music, photography, art, sculpture, painting, and more.

A preferred embodiment of the present invention offers creators a full spectrum of digital rights management, so that they may upload content and define their rights, before displaying said content to the world. Digital content has an infinite lifetime, so creators may profit throughout their lives, provided that they utilize this present invention to define and secure the rights before they set their content free upon the social network described herein and upon the world wide web. The rights they define may demand payment before the media is consumed, or it may entail that the user is to see an advertisement along with the content, for which the creator or owner of the content is paid.

Another preferred embodiment of the present invention allows users/creators to embed tags within their media so that advertising may be displayed on top, beside, and/or around the media. While millions of photos are displayed every day, nobody has ever sought to display advertising media on top of the photo, nor upon a corner of the physical photograph. For instance, the user would be able to upload their media to a flickr-like or myspace-like service, where an ad that they would be compensated for would be displayed in the said service.

This patent pertains to a method and apparatus that provides a novel means for establishing and growing content businesses related to photography, music, video, film, movies, fashion, and more.

More specifically, this invention relates to a novel social networking system wherein content and an ecommerce system are wed to the social network created by users. Whereas one can build a social network of friends in myspace™, facebook™, and other social networking sites, the present invention allows one to quickly and easily build a social network married to a content marketplace, thusly creating an ecommerce presence wherein all of one's favorite content is sold, both digital and real-world media such as books, printed art, and more. Whereas one can browse friends and friends of friends on networks such as myspace and friendster, the present invention allows one to browse a friend's ecommerce presence, as well as their friends' stores. Creators of content and networks are compensated utilizing a tiered system that is based upon the degree of separation within the network.

This invention relies on the networking preferences of three basic types of individuals.

1) the creator: the creator creates the art, be it a song, music, or fashion

2) the aggregator: the aggregator combines their favorite fashions, arts, and music

3) the viewer: the viewer rated the art, music, and more

This patent pertains to a method and apparatus that provides a novel means for establishing and growing content businesses related to photography, music, video, film, movies, fashion, and more.

### SUMMARY OF THE INVENTION

When users join the network described in this present invention, they may upload their own creative work, and/or link to other external works. They then may seek to join other groups, or wait to be invited. Through mutual interactions, users define the content and users that are associated with their groups. The present invention results in novel business scenario—over time, high-quality, trusted groups and ecommerce presences emerge, lending profitability to the social network model, and affording novel commercial opportunities to talented individuals and entities, be they creators, aggregators, producers, agents, or distribution companies.

The present invention allows the option of affording the creator with a full spectrum of digital rights management (DRM) options, via which they can encode, protect, watermark, and thumbnail their content. Such options will afford hitherto unseen business models, while bolstering the bottom line of current business models, and empowering creators in novel ways. Microsoft DRM may be combined with social networking technologies described in previous patents and technical literature, so as to provide a brand new business model.

### DRAWINGS

The present invention patent disclosure contains two sections describing preferred embodiments—the first is completely without drawing or figures, and the second section describing the preferred embodiment contains drawings and figures.

According to the USPTO site at: http://www.uspto.gov/web/offices/pac/mpep/documents/0600_{—}601_{—}01_f.htm
It has been USPTO practice to treat an application that contains at least one process or method claim as an application for which a drawing is not necessary for an understanding of the invention under 35 U.S.C. 113 (first sentence). The same practice has been followed in composition applications.—http://www.uspto.gov/web/offices/pac/inpep/documents/0600_{—}601_{—}01_f.htm

The present invention contains multiple method claims. Furthermore, the USPTO site http://www.uspto.gov/web/offices/pac/mpep/documents/0600_{—}601_{—}01_f.htm says,
Other situations in which drawings are usually not considered necessary for the understanding of the invention under 35 U.S.C. 113 (first sentence) are: (D) Articles, apparatus, or systems where sole distinguishing feature is presence of a particular material: where the invention resides solely in the use of a particular material in an otherwise old article, apparatus or system recited broadly in the claims, for example: (1) A hydraulic system distinguished solely by the use therein of a particular hydraulic fluid;

A distinguishing feature of this invention is the use of a revenue-sharing algorithm in the context of a social network. Another distinguishing feature of the present invention is the introduction of DRM to a social network, so that users might protect and profit from their content. These two distinguishing features, when weighed on their own, would signify a novel invention. The field of social networks is a crowded art, and such distinguishing features as described herein would gave a great advantage to any social networking system using them, both in allowing users to build greater value, and in fostering greater value for the network as a whole.

The present invention contains variations on an algorithm for sharing revenue within the context of a social network that is married to content archives and marketplaces that generate revenue via ecommerce and/or sales of advertising. The said novel algorithm uses the commonly defined degrees of separation between commonly defined nodes in a commonly defined social network to calculate a revenue sharing program for users of the said social network. The end result of implementing the said algorithm is the creation of new and improved business models, enhanced social network communities, and marketplaces and archives of quality content. It was not immediately apparent that the functioning of the algorithm could be better depicted with drawings, nor that the functionality of the present invention could be better depicted in drawings. But the present inventor would be happy to provide drawings, reflecting the functionality of the present invention, upon request.

A preferred embodiment of the present invention is a) a social network distinguished by the marriage of salable content to the underlying social network so as to facilitate novel ecommerce presences wherein users are compensated according to an algorithm that is based on the degrees of separation between the nodes of where the buyer entered, to where they bought the product, and also the degrees of separation of nodes from where the original owner set up shop and how many nodes were traversed to find the content to add to the store. Another preferred embodiment of the present invention is b) a social network distinguished by the marriage of DRM to a marketplace or archive of content built atop a social network. Another preferred embodiment of the present invention is c) a social network distinguished by the addition of the ability of a user or creator to embed advertising in and around the content they upload. Another preferred embodiment of the present invention is d) a social network distinguished by the addition of the ability of a user or creator to include content from branded affiliates in which they receive a commission when they sell said marquee content, such as blockbuster movies produced by major studios.

### DETAILED DESCRIPTION—PREFERRED EMBODIMENTS

The present invention pertains to a novel means for creating ecommerce presences relating to creative content.

A person skilled in the art of programming with web technologies could build the present invention, as described herein. A person skilled in the art of programming could integrate the novel algorithms disclosed below which allow for builders of social networks and participants in social networks to receive percentage shares of revenue generated by ecommerce and advertising. The algorithms behind social networking and digital rights management are public and well known, with extensive documentation both in research papers and patent archives, as well as live site that can easily be reverse-engineered. The technology behind web-servers and databases and ecommerce is extensively documented in books, literature, and throughout the web.

The object of this present invention disclosure is not to duplicate the extensive knowledge pertaining to social networks and web technologies which has already been disclosed extensively in multiple places; but the object of this invention is to teach someone skilled in the art how to build the present invention that consists of new combinations and novel modifications made in a crowded art which will have far-reaching and extensive consequences in the realm of business and ecommerce, opening up new opportunities and revolutionizing the way content is distributed and monetized.

This present invention explains how one might build a superior and hitherto unseen platform for content marketplaces, by marrying existing social networking technology to content archives and ecommerce. This present invention also explains how one might build a superior and hitherto unseen platform for content marketplaces, by marrying existing social networking technology to content archives and ecommerce which afford the user a full spectrum of digital rights management, which may include Creative commons licenses and Microsoft DRM.

Nowhere in the prior art is a full spectrum of digital rights management, including both CC licenses and Microsoft DRM provided. Nowhere in the prior art is a full spectrum of digital rights management, including both CC licenses and Microsoft DRM provided, alongside the ability to embed advertising in and around content. Furthermore, nowhere in the prior art is a social networking system provided that compensates creators based on the networks they build, utilizing an algorithm that computes a tiered revenue-share structure based upon the numbers of nodes a purchaser traverses, and/or the number of nodes the store-owner traverses in building their store. Many specific algorithms could be arrived at, but the important thing is that none of the prior art incorporates any such algorithm that computes a revenue-share that is includes both the number of nodes traversed by the purchaser after they enter the site, compensating the owners of said nodes in some way, and the number of nodes traversed by the store-owner in building aggregating the content in their store, compensating the owners of the nodes they traversed. All this information may easily be extracted, and the main spirit of the algorithms discussed in this invention is to compensate those who build the social networks—the users of social networking sites.

To build the present invention, social networking software may be bought as a commercial package, or it may be created from scratch by a small team of programmers skilled in the art of web technologies. A web programmer, after creating or installing a social network, would then associate content IDs with the user IDs in the database. Thus when a user ID was accepted into a node, the content ID(s) would be accepted into the same node. Then, a web programmer would add a layer of rights definitions, which could be in the form of a web form that is used in uploading content, wherein the user would define rights and information about the content using standard form features such as selection boxes and drop-down menus. Default values could be implemented so as to save the user time when uploading multiple piece of content. And too, uploading software could be developed to facilitate mass uploads.

Digital rights management services may also be bought in commercial packages, from companies such as Microsoft, or created from scratch or in conjunction with the work of Open Source approaches such as the Open IPMP project headed by objectlab.com. A web developer could skilled in the art could easily marry Microsoft DRM to the present invention, thusly allowing users to define rights in the context of a commercial DRM package.

A preferred embodiment of the present invention could be easily built upon a LAMP (Linux, Apache, MYSQL, PHP) server. Microsoft digital rights management could be used to provide the DRM licenses from a separate Windows server. One of several social networking packages could be used on either a LAMP server or a Windows server. The key would be associating the database of content with the database of users, in a way such that that relationships defined by the users also defines the relationship of the content—any web developer skilled in the art could create this in a standard relational database such as MYSQL, which is used for the preferred embodiment. A second, but not necessary feature for the novelty of the present invention, would be to allow the user to define the rights to their content. Anyone skilled in the art of web and database development could build the present invention, either alone or with a small team, depending on their talents.

A user would be able to choose to display advertising on or around their content, and or define the following rights, as provided by Microsoft DRM or any similar system. Novel marketplaces and hitherto unknown business opportunities will result when DRM is married to social networks.

The purpose of this invention is neither to disclose how to build social networks, which has been done previously and extensively, nor to disclose how to implement DRM, which has also been done previously and extensively. Rather, the a goal of this present invention is to show how marrying DRM to social networking systems will result in previously unchartered business scenarios and enhanced business opportunities for creators, users, aggregators, and social networks alike. The goal of this present invention is to teach how to build a superior social network that could foster novel business models—tie the content in the database to nodes created by the users in their mutually-defined relationships, and then allow the selling of content while sharing revenues based on a simple algorithm that takes into account both the nodes the buyer traverses en route to purchasing the content, as well as the nodes traversed by the builder of the network underlying the ecommerce presence in aggregating content and inviting users and their associated content.

Any user in the art could build this, and an algorithm could be as follows.

The revenue share is determined as follows:

50% of the revenue share could be determined from the nodes traversed en route to the content purchased. Alternatively, 100% of the revenue could be determined from the nodes traversed en route to content purchased. Or some other arbitrary percentage to be determined by owners of the network.

50% of the revenue is determined from the nodes traversed en route to aggregating the content. Alternatively, 100% of the revenue could be determined from the nodes traversed en route to content purchased. Or some other arbitrary percentage to be determined by owners of the network.

Let us begin with a disclosure of a couple preferred embodiments, which may be combined into other preferred embodiments.

So suppose the store owner traversed node a, b, and c, en route to finding their content at node d.

Then suppose the buyer traversed node i, j, and k before finding their content at node l and buying said content.

And then suppose the buyer paid $10 for the content. So T=$10.

A preferred embodiment of the algorithm would work as follows. The owners of the social network may determine how many nodes ought to be paid. Let's say it is four. Then the formula works like this. When the content is purchased, the last four nodes traversed are examined. Or, the first two and last two nodes are examined. Or some other variation of nodes are taken into account, based on the preferences of the network owners. But consider that we are taking the last four nodes into account, so U=4. The network decides to take 20% of the transaction, so P=20%, and the owners of the nodes split the rest as follows, based on their degree of separation, where the degree of separation is denoted as S. An owner of a node is defined as a user who has registered for the social network, and who is free to create a social network by inviting other users, accepting the invitations of other users; and who is free to build content marketplaces adding content of users in his mutually-defined network. The node-share is given as follows:

Node Share = (((U + 1) * 2 − (S * 1.5 + 5)) * 10)%
So NS = ((U + 1) * 2 − (S + 1) * 3)% * (T − P * T)
And S = 0, 1, 2, 3.
So the primary node-node 0-where the product is bought from,
receives:
Node 0: NS = (((U + 1) * 2 − (S * 1.6 + 5.1)) * 10)% * (T − P * T)

= 49% * $8 = $3.92.

The secondary node, one degree of separation from the primary node,
receives:
Node 1: NS = (((U + 1) * 2 − (S * 1.6 + 5.1)) * 10)% * (T − P * T)

= 33% * $8 = $2.64.

The third node receives:
Node 2: NS = (((U + 1) * 2 − (S * 1.6 + 5.1)) * 10)% * (T − P * T)

= 17% * $8 = $1.36.

The fourth node receives:
Node 3: NS = (((U + 1) * 2 − (S * 1.6 + 5.1)) * 10)% * (T − P * T)

= 1% * $8 = $.08.

And so it is that a preferred embodiment of a physical manifestation of this invention would be as follows. After a $10 sale of a piece of content:

Social network gets $2

Owner of Node 0 in social network gets $3.92.

Owner of Node 1 in social network gets $2.64.

Owner of Node 2 in social network gets $1.36.

Owner of Node 3 in social network get $0.08.

And so it is that in one preferred embodiment of the present invention, the owners of nodes in a social network, being the users who created the nodes and populated them, come to share the profits with those who traversed their nodes en route to purchasing content. The above formula in the above algorithm may be altered in many ways, while still falling within the scope and spirit of the invention. The preferred embodiments in no way preclude other embodiments.

Another preferred embodiment of the algorithm would work as follows. The owners of the social network may determine how many nodes traversed by the primary store owner in building the content store ought to be paid. Let's say the maximum is four nodes. Then the formula works like this. When a specific piece of content is purchased, the last four nodes traversed by the store owner are examined. Or, the first two and last two nodes are examined. Or some other variation of nodes are taken into account, based on the preferences of the network owners. But consider that we are taking the last four nodes into account, so U=4. The network decides to take 20% of the transaction, so P=20%, and the owners of the nodes split the rest as follows, based on their degree of separation, where the degree of separation is denoted as S.

Node Share=(((U+1)*2−(S*1.5+5))*10)%

So NS=((U+1)*2−(S+1)*3)%*(T−P*T)

And S=0, 1, 2, 3, representing the four nodes the store owner traversed in finding content and users and inviting said users and content to join their store, while building their content archive and marketplace.

So the primary node—node 0—where the final product resides, receives:

Node 0: NS=(((U+1)*2−(S*1.6+5.1))*10)%*(T−P*T)
=49%*$8=$3.92.

The secondary node, one degree of separation from the primary node, which the store owner originally had to traverse before meeting the owner of the content that is sold, receives:

The secondary node, one degree of separation from the primary node, receives:

Node 1: NS = (((U + 1) * 2 − (S * 1.6 + 5.1)) * 10)% * (T − P * T)

= 33% * $8 = $2.64.

The third node receives:
Node 2: NS = (((U + 1) * 2 − (S * 1.6 + 5.1)) * 10)% * (T − P * T)

= 17% * $8 = $1.36.

The fourth node receives:
Node 3: NS = (((U + 1) * 2 − (S * 1.6 + 5.1)) * 10)% * (T − P * T)

= 1% * $8 = $.08.

And so it is that a preferred embodiment of a physical manifestation of this invention would be as follows. After a $10 sale of a piece of content:

Social network gets $2.

Owner of Node 0 in social network gets $3.92.

Owner of Node 1 in social network gets $2.64.

Owner of Node 2 in social network gets $1.36.

Owner of Node 3 in social network get $0.08.

And so it is that in an another preferred embodiment of the present invention, the owners of nodes in a social network, being the users who created the nodes and populated them, come to share the profits with those who traversed their nodes en route to purchasing content. The above formula in the above algorithm may be altered in many ways, while still falling within the scope and spirit of the invention. The preferred embodiments in no way preclude other embodiments.

The nodes in the compensation algorithm could be reversed in the algorithm, or the nodes could be staggered, making the first node the node of entry into the network, the second node the node of purchase, the third node one degree removed from the node of entry, along the traversed path towards the node of purchase, the fourth node one degree removed from the node of purchase, along the path towards the point of entry, and so on.

Yet another preferred embodiment would combine the algorithms above into a new algorithm computing tiered revenue sharing based on nodes, so that both the owners of nodes traversed by the buyer of the content, and the owners of the nodes traversed while the store owner is building their content marketplace and archive, are compensated in some fashion proportional to the degrees of separation of traversed nodes. Thus those who build the network are rewarded in novel ways that are absent from the prior art.

Yet another preferred embodiment, and perhaps superior embodiment, would include algorithms as those just described, but instead of sharing revenue based on revenue generated from ecommerce transactions, revenue would be shared based on revenue generated from advertising, where again the primary node would receive the most, and the rest of the nodes would receive less based on an algorithm that scaled the revenue downward in proportion to the number of traversed nodes separating the primary node from the node whose compensation it is to be determined.

In another preferred embodiment, the content price, which is set at $10 in the above preferred embodiments, would be integrated with a digital rights management system, such as Microsoft DRM, so as to afford protection. DRM systems such as Microsoft DRM are elaborated on further in this present invention, and they are disclosed extensively throughout the web. Other DRM systems may be used.

In another preferred embodiment, the content price, which is set at $10 in the above preferred embodiments, would be integrated with a digital rights management system, such as Open IPMP DRM, so as to afford protection. DRM systems such as Open IPMP DRM are elaborated on further in this present invention, and they are disclosed extensively throughout the web. Other DRM systems may be used.

Yet another simple variation of the preferred embodiment is as follows.

50% if any product purchased goes to the content creator, so that is $5.

(100−N*20)% goes to each node traversed by the store owner with the most going to the node where the content was located, so d gets 80% of 50%, c gets 60% of 50%, b gets 40% of 50%, and a gets 20% of 50%. Anything five nodes and beyond gets nothing, but this can be changed.

(100−N*20)% goes to each node traversed by the buyer with the most going to the node where the content was bought, so I gets 80% of 50%, k gets 60% of 50%, j gets 40% of 50%, and i gets 20% of 50%. Anything five nodes and beyond gets nothing, but this can be changed.

The above disclosed algorithms could be easily implemented within the context of a social network by anyone skilled in the art of web development. Content management systems abound, and they too could easily be integrated in the context of a social network by anyone skilled in the art of web development. Indeed, social networks such as myspace and facebook already allow users to upload and manage content, but this present invention introduces modifications that allow users to profit from the social networks they create.

For instance, a preferred embodiment would feature a menu with the following options when content is uploaded:

1. Encrypt with Microsoft DRM

2. Encrypt with OPENIPMP DRM

3. Encrypt with other DRM

4. Release under Creative Commons License

5. Use GNU Documentation License

6. Embed with advertisting

7. Set price

Selections on this menu would take the user to their sub-menus where they could define their rights with greater detail.

The above menu could include other options so as to afford a full spectrum of digital rights management, as other DRM options become available.

For instance, a social network such as that described in U.S. Pat. No. 6,175,831 or U.S. Pat. No. 7,069,308 may be married to content uploaded by users and an ecommerce system as described within this present invention by somebody skilled in the art of social networks and web development. Furthermore, such a system could be married to a system that would allow the user to define their rights within a full spectrum of rights management systems and options, and enforce with their rights with digital rights management protocols such as those offered by Microsoft. Someone skilled in the art of web development could implement this.

The following Microsoft DRM functionality could be included and offered to the end user at an inexpensive rate or for free. The following Microsoft DRM functionality could easily be added to a social network, affording the user a fuller spectrum of digital rights options. Microsoft DRM functionality is described at: http://www.microsoft.com/windows/windowsmedia/forpros/dnn/faq.asnx as:

1.4 How does Windows Media DRM Work?
The basic Windows Media DRM process is as follows:

1. Packaging
Windows Media Rights Manager packages the digital media file. The packaged file has been encrypted and locked with a key. This key is stored in an encrypted license, which is distributed separately. (This feature is unique to Windows Media Rights Manager.) Other information is added to the digital media file, such as the URL where the license can be acquired. This packaged digital media file is saved in Windows Media Audio format (file with a .wma file name extension) or Windows Media Video format (file with a .wmv file name extension).

2. Distribution
The packaged file can be placed on a Web site for download, placed on a digital media server for streaming, distributed on a CD, or e-mailed to consumers. Windows Media DRM permits consumers to send copy-protected digital media files to their friends as well.

3. Establishing a License Server
The content provider chooses a license clearing house that stores the specific rights or rules of the license and implements the Windows Media Rights Manager License Service. The role of the clearing house is to authenticate the consumer's request for a license. Digital media files and licenses are distributed and stored separately, making it easier to manage the entire system.

4. License Acquisition
To play a packaged digital media file, the consumer must first acquire a license key to unlock the file. The process of acquiring a license begins automatically when the consumer attempts to acquire the packaged digital media file, acquires a pre-delivered license, or plays the file for the first time. Windows Media Rights Manager either sends the consumer to a registration page where information is requested or payment is required, or “silently” retrieves a license from a clearing house.

5. Playing the Digital Media File
To play the digital media file, the consumer needs a player that supports Windows Media DRM. The consumer can then play the file according to the rules or rights that are included in the license. Licenses can have different rights, such as start times and dates, duration, and counted operations. For instance, default rights may allow the consumer to play the digital media file on a specific computer and copy the file to a portable device. Licenses, however, are not transferable. If a consumer sends a packaged digital media file to a friend, this friend must acquire her own license to play the digital media file. This PC-by-PC licensing scheme ensures that the packaged digital media file can only be played by the computer that has been granted the license key for that file.

1.5 What are Some of the Features in Windows Media DRM?
Windows Media DRM contains a number of features that protect the content file and enables new flexible business models.

Security

Individualization
Windows Media DRM improves the security of the system by making each digital media player unique and linking the player to the host computer. This reduces the likelihood that a compromised player will be widely distributed on the Internet. With individualization, any compromised player can be identified and disabled in the licensing process.

Application Exclusion
Windows Media DRM enables the license issuer to prohibit an application from playing certain packaged files.

DRM Component Exclusion
Windows Media DRM enables the license issuer to deny licenses to applications that use a DRM component that is known to be damaged or corrupted.

Secure Audio Path
Windows Media DRM ensures digital media file protection in the operating system from the player to the sound card driver in Microsoft Windows Millennium Edition, Microsoft Windows XP. This secure relationship reduces the likelihood that any unauthorized program will capture a digital media stream within a computer.

License Acquisition

License Chaining
This feature allows content services to create “root” licenses (which contain information that governs whether or not a file can be played, such as expiration date) and “leaf” licenses for the content itself. This is useful for subscription services because only the single root license needs to be updated for each renewal period as opposed to renewing hundreds or thousands of individual content licenses.

License Store Performance
The redesigned license store reduces the time necessary to manage licenses.

Playback

Start and End Times
Content providers can create specific playback time periods for their digital media files. For example, a rental model could be established where consumers could play back a streaming media file during a three-day period. This time period may begin some time in the future and last for a limited duration.

Playback Duration
Content providers can specify an amount of time during which playback of a given digital media file is permitted. This time period may begin the first time the file is played or saved to a computer.

Counted Operations
The single play or limited play option allows the content provider to limit the number of times that the consumer can play a digital media file.

1.6 Why is Digital Rights Management Important?
Digital media files can be easily copied and distributed without any reduction in quality. As a result, digital media files are being widely distributed on the Internet today, through both authorized and unauthorized distribution channels. Piracy is a concern when security measures are not in place to protect content. Digital rights management enables content providers to protect their content and maintain control over distribution. Content providers can protect and manage their rights by creating licenses for each digital media file. License registration procedures also give these companies important customer information. Such information helps content providers stay closer to their customers. Having a robust DRM system in place ensures that a wide variety of the highest-quality audio and video content is made available to consumers.
Above Microsoft™ DRM Description From: http://www.microsoft.com/windows/windowsmedia/forpros/drm/faq.aspx

The novelty of the present invention is that it combines content archives and marketplaces and social networks in a novel, non-obvious, and hitherto unseen way. The additional novelty of the present invention is that it combines digital rights management and social networks in a novel and non-obvious way. Indeed, the combination counters expert opinion of both famous technology experts and esteemed Stanford lawyers, discussed elsewhere in this application, who have argued cases before the supreme court.

Furthermore, the same technology that powers a social network may also power the method via which content is selected and displayed within a content archive and/or marketplace. All that needs be done is have the content uploader or content owner user IDs in a database associated with content IDs in a database, so that the content is displayed in the same context of the social networks, marketplaces, and archives that users participate in and create via mutually-defined linkage. Such a setup could be easily implemented by a web developer skilled in the present art, building upon common and present social networking technologies. So it is that this invention suggests a new use for existing technology. The new use, along with minor modifications, will result in an effectively new technology that leads to hitherto unseen business opportunities and revenue streams for creators, users, aggregators, producers, and owners of social network systems.

A new technology within this invention is the ability to compensate creators of content archives and marketplaces based on a tiered compensation structure. For instance, in yet another preferred embodiment a percentage share algorithm may be set up, so that in one preferred embodiment, a user received 100% of the revenue from their own content, 90% of the revenue for content one link removed from their network, 80% of the revenue for content two links removed from their network, and (100−n* 110)% of the revenue wherein n is the number of links removed from the primary network. The exact numbers and algorithms may be varied in different embodiments, while still falling under the scope of this invention whose purpose it is to enrich and compensate the builders of networks.

Such an algorithm will foster brand new business models, encouraging artists, creators, producers, and users to spend hours building out social networks and aggregating and arranging content.

No longer will spending time on a social network be relegated to collecting friends and looking at pictures, but one will be building a viable, novel business that this present invention affords.

Thus the more content a user is able to aggregate on their own page or within their own store, the more money they will make. Also, the more prestigious and better content marketplaces they are able to create and link to, the more money they will make.

Thus the above novel algorithms, and modifications in the realm of their general spirit, will lead to hitherto unseen business models, revenue streams, and varieties of content marketplaces and archives.

In one preferred embodiment, the content users display on their storefront must be approved by the original creators or owners of the content.

In another preferred embodiment, the system would allow the user to invite other users, and/or other user's created works, to join their network.

In another preferred embodiment, users may only be allowed to browse friends and friends of friends.

In another preferred embodiment, users may be allowed to browse everyone upon signing in.

In another preferred embodiment, certain regions and presences or archives or marketplaces may be set to private, so that only approved users may browse said marketplaces.

In another preferred embodiment, users are afforded a full spectrum of digital rights management options for defining their rights and protecting their content.

In another preferred embodiment, users are afforded the ability to watermark all of their content.

In another preferred embodiment, users are afforded the ability to have ads displayed on or beside their content, and receive revenue for said ads.

In another preferred embodiment, users are afforded the ability to serve ads on their content and join other networks where they receive a cut of the percentage of the ads served, based on a tiered commission structure that is based upon the underlying social network.

In another preferred embodiment, on the computer screen users see only the content in the network at a given node.

In another preferred embodiment, on the computer screen users see only the owners of content in the network at a given node.

In another preferred embodiment, on the computer screen users see only the aggregators of content in the network at a given node.

In another preferred embodiment, on the computer screen users see only the friends of the node at a given node.

In another preferred embodiment, on the computer screen can toggle between content, owners, nodes, aggregators, maps of nodes, and more.

In its simplest manifestation the present invention is a social network that allows users to upload content and define the said content's rights. The user is offered a full spectrum of rights management, ranging from Creative Commons licenses to Microsoft's DRM. Presently there exists no system, let alone a social network, that provides the ability to associate a content marketplace with friends, groups, and other entities inherent to a social network. Presently there exists no system, let alone a social network, that provides the ability to associate content with a full spectrum of rights management. By providing the user with the freedom and ability to define their content's rights, new business models will be afforded.

An additional feature to the present invention is the ability of a user to select other user's content to include within their content network, which is also an ecommerce store. A preferred embodiment would provide an AJAX interface wherein users could drag and drop their friend's and others' content into their own storefronts. Thus one would be able to create novel, branded content portals within the context of a social network. Such a social network could most easily be built in a system where users tag the content, defining such attributes as price and rights.

### DRAWINGS

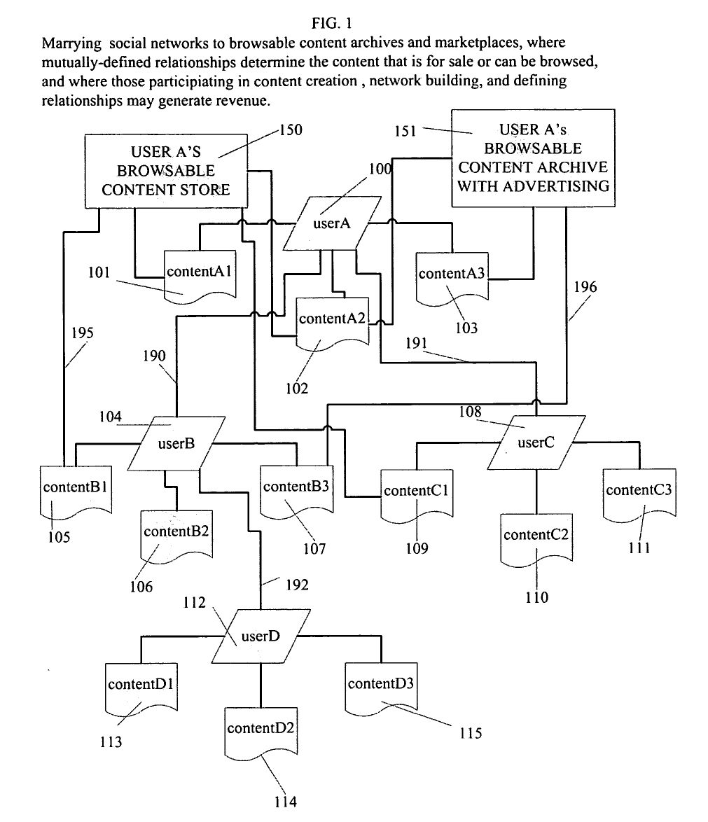

FIG. 1 introduces the concept of marrying social networks to browsable content archives and marketplaces, where mutually-defined relationships determine the content that is for sale or can be browsed, and where those participating in content creation, network building, and defining relationships may generate revenue.

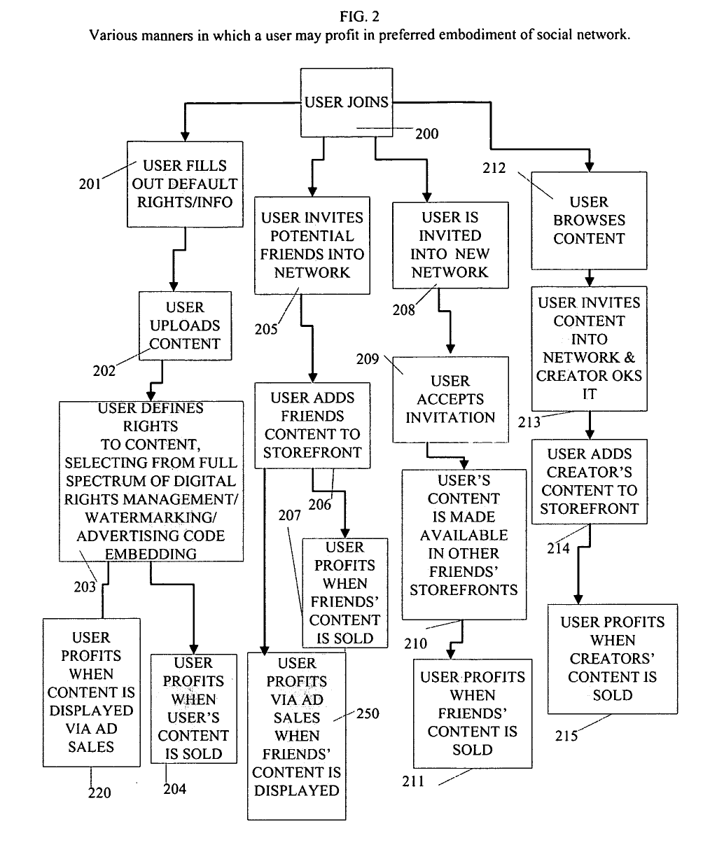

FIG. 2 shows various manners in which a user may profit in a preferred embodiment of the present invention's social network.

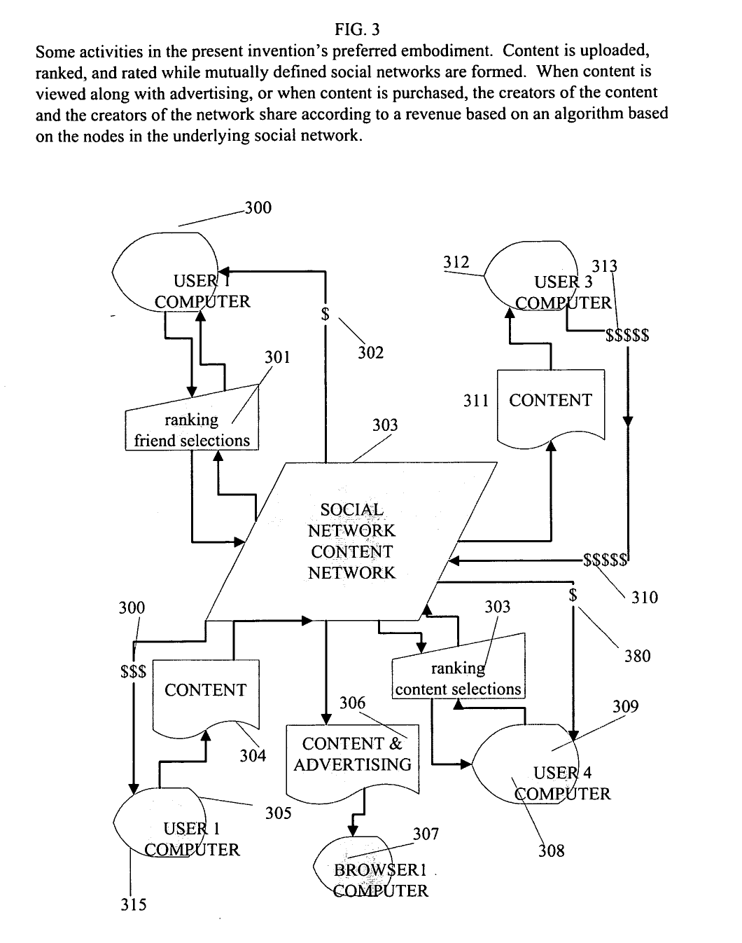

FIG. 3 shows some activities in the present invention's preferred embodiment. Content is uploaded, ranked, and rated while mutually defined social networks are formed. When content is viewed along with advertising, or when content is purchased, the creators of the content and the creators of the network share according to a revenue based on an algorithm based on the nodes in the underlying social network.

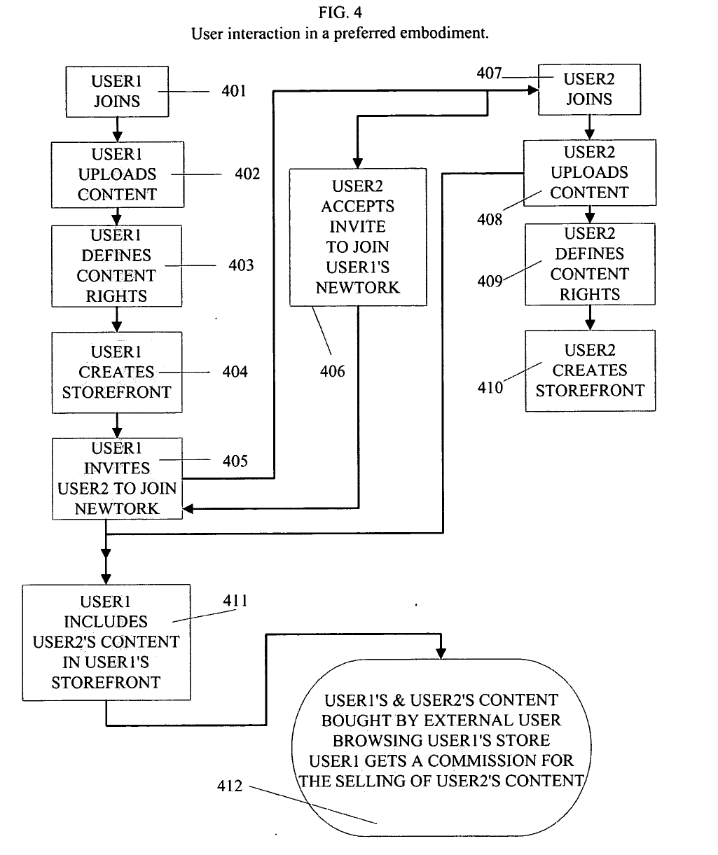

FIG. 4 shows user interaction in a preferred embodiment, wherein users befriend one-another according to the prior art in social networking, but are then able to upload content and define its rights, and show and sell each-other's content.

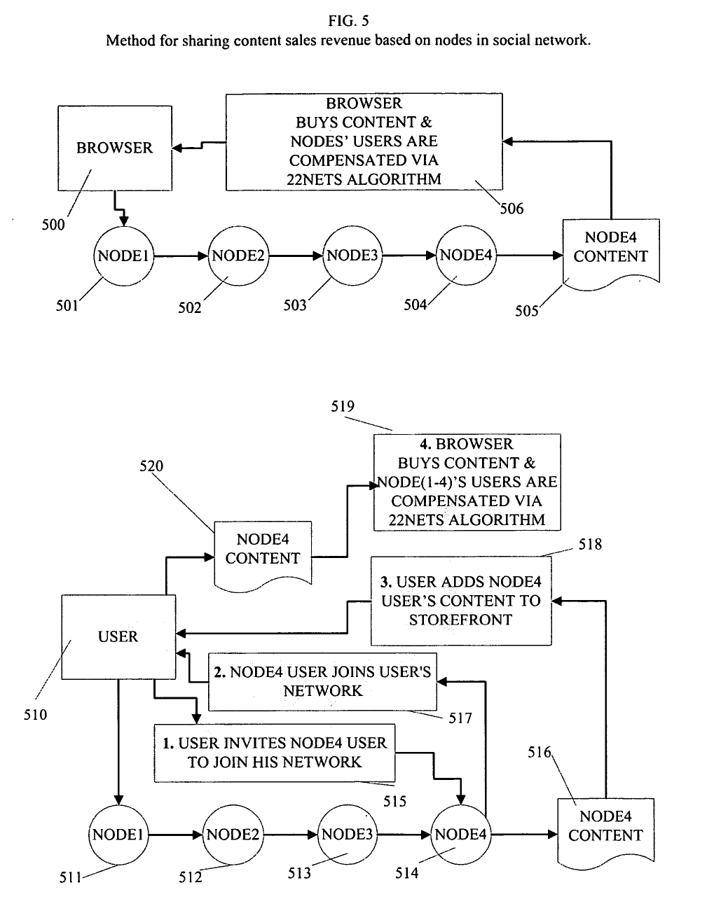

FIG. 5 shows a method for sharing content sales revenue based on nodes in social network.

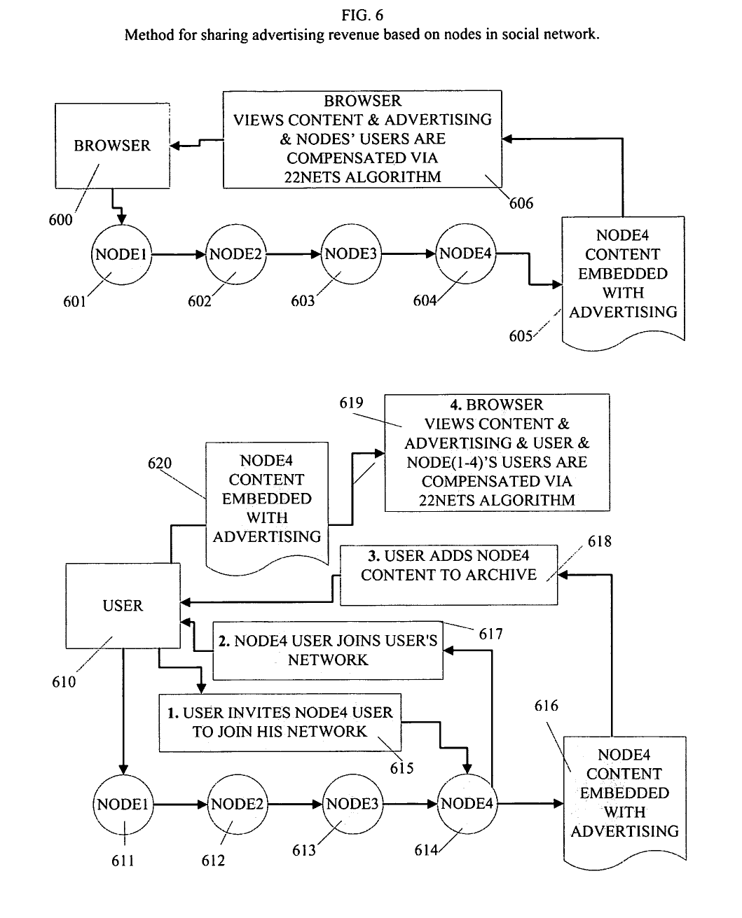

FIG. 6 shows a method for sharing advertising revenue based on nodes in social network.

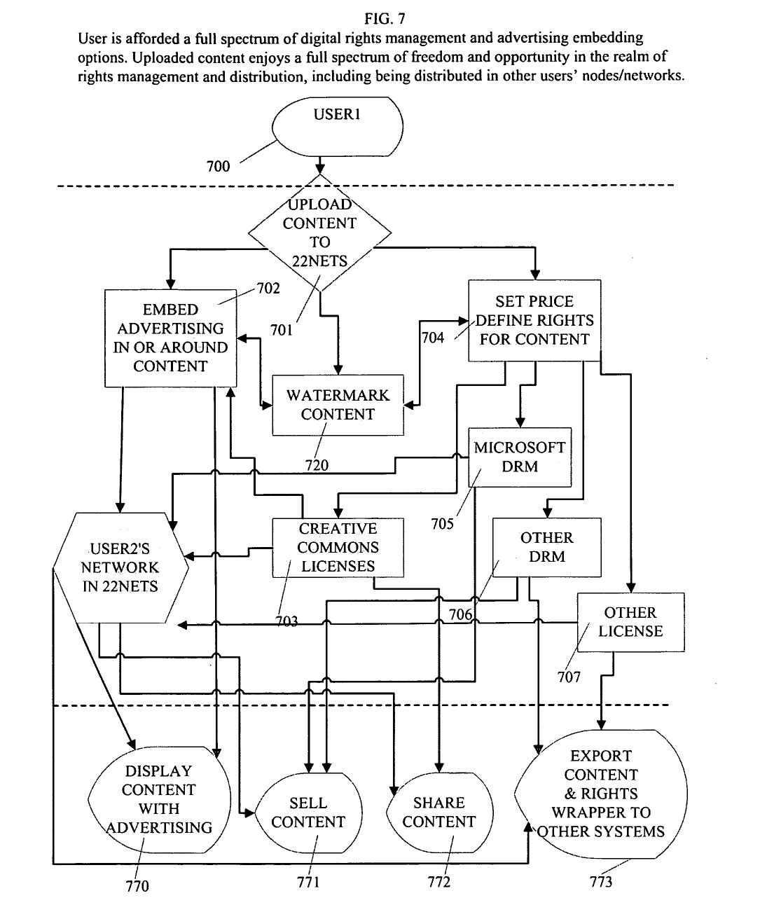

FIG. 7 shows how the user is afforded full spectrum of digital rights management and advertising embedding options. Uploaded content enjoys a full spectrum of freedom and opportunity in the realm of rights management and distribution, including being distributed in other users' nodes/networks.

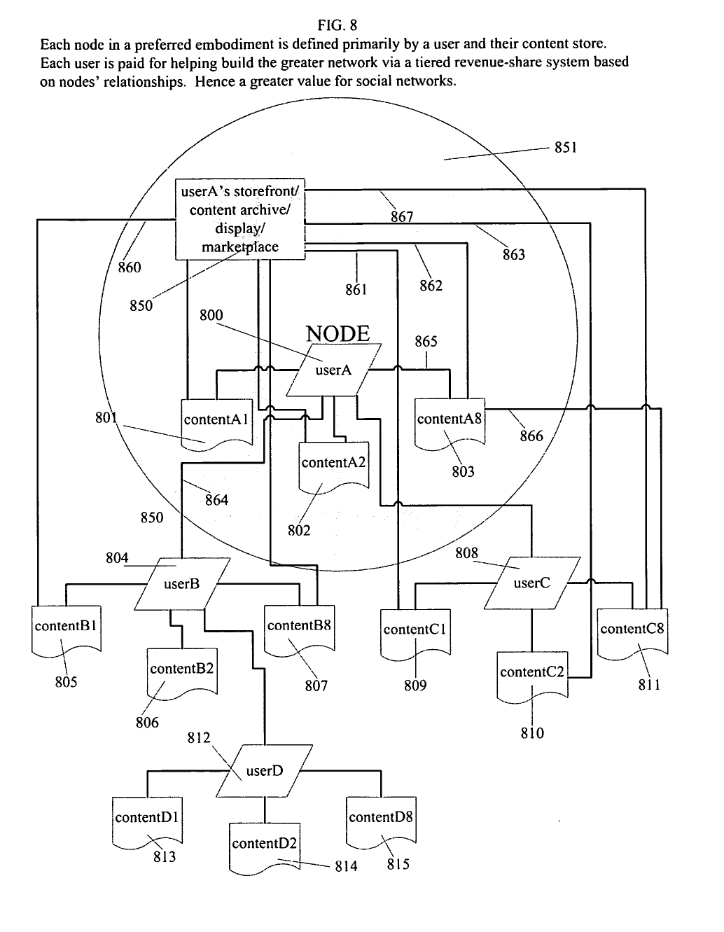

FIG. 8 defines a node in a novel way, as it marries commercial content to the user node in a social network. Each node in a preferred embodiment is defined primarily by a user and their content store. Each user is paid for helping build the greater network via a tiered revenue-share system based on nodes' relationships. Hence a greater value for social networks.

### DETAILED DESCRIPTION—PART 2 PREFERRED EMBODIMENTS WITH DRAWINGS

### Drawings—Figures

FIG. 1 introduces the concept of marrying social networks to browsable content archives 150 and marketplaces 151, which can be browse by any user with internet access, where mutually-defined relationships 190, 191, 192, 195, 196 determine the content that is for sale on display and can be browsed, and where those users 100, 104, 108, 112 participating in content creation, network building, and defining relationships may generate revenue via sales of advertising in the browsable content store 150, wherein revenue is generated via ecommerce, and the content archive 151, wherein revenue is generated via advertising.

FIG. 2 shows various manners in which a user 200 may profit in a preferred embodiment of the present invention's social network. One way is the user 200 joins the network, and they then fill out their default rights info 201, including name, address, business entity, billing and mailing address for payments, and a default price for their content. The user then uploads content 202, and defines their rights from a full spectrum of digital rights management and watermarking options 203 which were discussed earlier and are also presented more elaborately in subsequent figures. The user then may profit when content is either displayed along with an ad 220, or when it is sold via an ecommerce transaction 204.

Another path the user may follow towards profitability is that a user joins and then starts aggregating friends by inviting them 205. When friends accept, mutually-defined relationship is formed, and the user can then start including the friends in his storefront or content archive, where he can add their content to his storefront 206 and sell their content and receive a commission 207, or receive a commission for any advertising displayed around the content 250 be it in a marketplace or archive.

Upon joining, a user may invited into a new network 208, and she may accept the invitation 209. Her content will then be made available in the new network which she has just joined 210. She profits, by earning a commission, whenever any of her content is sold. Also, if she embeds advertising in her content, or wishes to have advertising associated with it, she may also profit when her content is displayed with associated advertising, receiving a split based on an algorithm that mines the information within the nodes traversed.

Another way that relationships are formed begin with a user browsing content in 212, instead of other users. Seeing content she likes, she invites the content into her present network 213. The content creator/owner accepts the invitation 213, and the content become available for sale or display as the user organizes it as they see fit, using an AJZ drag-and-drop interface. The content may display optional advertising within the user's store, depending on how the original creator tagged it. Then, whenever this new piece of content is sold, both the user and the original creator/owner profit, each earning a commission to be determined by an algorithm based on the nodes of the social network. Also, if there is advertising associated with the network, a profit will be made and shared accordingly as in 220 and 250.

FIG. 3 shows some activities in the present invention's preferred embodiment. Content is uploaded, ranked, and rated 301 while mutually defined relationships in a social network 303 are formed. A network of content 303 is married to the social network 303. A participant in the network 315 uploads content and sets a price and or embeds it with advertising. When content is viewed along with advertising 306 by people 307 browsing the social network from a web interface, or when content is purchased by people shopping via web interface 312, 313 the creators of the content 315 and the creators of the network 308, 300 share 300, 302, 380 the revenue according to a tiered-revenue sharing system based on an algorithm based on the nodes in the underlying social network 303.

FIG. 4 shows user interaction in a preferred embodiment, wherein USER1 401 and USER2 407 befriend one-another according to the prior art in social networking, but are then able to upload content 402, 408 and define its rights 403, 408, and show and sell their own 404, 410 and each-other's content 411. The ability of USER1 to show and sell USER2's content is predicated upon USER2 joining USER1's network, or vice versa. In this case, USER1 invites USER2 405 to join his network. USER2 accepts USER1's invitation 406, and USER1 includes USER2's content in his storefront 411. When a third external or internal user buys USER2's content, USER1 and USER2 share the revenue based on an algorithm that depends upon the separation of nodes and their previous history of interactions that was recorded in the formation of their mutually-defined relationship, and their mutually-defined segment of the social network.

FIG. 5 shows a method for sharing content sales revenue based on nodes in social network. The spirit and functionality of this figure was elaborated on heavily and thoroughly in the previous section which presented detailed descriptions and preferred embodiments without the use of drawings. The drawing illustrates the same ideas as previously elaborated on. The 22nets algorithm results in a means for calculating a revenue sharing between content creators and builders of social networks. A browser 500 enters the 22nets social network at a given node NODE1 501. During the course of surfing, looking at users and content, the browser then proceeds to NODE2 502, and then on to NODE3 503, and NODE4 504, whereupon the browser sees content they like, and they purchase it 506. The owners of the nodes are then all compensates according to an underlying algorithm which rewards and encourages builders of nodes by offering a tiered revenue system. Such a system was elaborated on in a specific mathematical formulation in a previous section, but the specific mathematical formula of the previous preferred embodiment is not what is being patented. Rather the idea of using an algorithm that calculates revenue share on nodes passed while browsing is being patented herein.

The administrator of the social network may adjust the number of nodes and the percentage revenue shares in the previously suggested algorithms, or they introduce entirely new algorithms that mine the information inherent within nodes so as to compensate creators of content who participate in and build the social network, and associated content archives and marketplaces.

Also shown in FIG. 5 is a method for rewarding builders of stores and owners of nodes that are traversed as the builder of a content archive surfs around and finds content to add to their own store. Administrators of the social network may limit the depth to which a user may see other people's content or other people's friends, based on the degrees of separation. But no matter what, the builders of the nodes ought to benefit when others cme through their nodes in search of content. Such a system was elaborated on in a specific mathematical formulation in a previous section, but the specific mathematical formula of the previous preferred embodiment is not what is being patented. Rather the idea of using an algorithm that calculates revenue share on nodes passed while browsing is being patented herein.

A user 510 is interested in building a content presence. They join and start surfing, passing NODE1 511, NODE2 512, NODE3 513, NODE4 514, and finding content they would love to include in their store 516. The user invites the NODE4 514 user to join their network 515. The NODE4 514 user accepts 517. The user 510 then adds 518 NODE4 514 user's content 516 to his store. An external browser or other user buys 519 the NODE4 516 content 520 from the user's 510 store. The owners of NODES 1-4 are then all compensated by an algorithm that recorded the nodes the original user traversed in finding content for his store.

So it is that enhanced and improved social networks, as well as novel business models and opportunities may be provided for users of the present invention, including creators, aggregators, and owners of entire socially networking systems built with the systems presented herein.

FIG. 6, similar to FIG. 5, shows a method for sharing advertising revenue based on nodes in social network. Whereas revenue derives from sharing ecommerce proceeds deriving from content sold in FIG. 5, revenue in FIG. 6 derives from shared advertising revenues. The spirit and functionality of this figure was elaborated on heavily and thoroughly in the previous section which presented detailed descriptions and preferred embodiments without the use of drawings. The drawing illustrates the same ideas as previously elaborated on. The 22nets algorithm results in a means for calculating a revenue sharing between content creators and builders of social networks. A browser 600 enters the 22nets social network at a given node NODE1 601. During the course of surfing, looking at users and content, the browser then proceeds to NODE2 602, and then on to NODE3 603, and NODE4 604, whereupon the browser sees content they like, and as they view it, they also see a paid advertisement. The owners of the nodes are then all compensates according to an underlying algorithm which rewards and encourages builders of nodes by offering a tiered revenue system. Such a system was elaborated on in a specific mathematical formulation in a previous section, but the specific mathematical formula of the previous preferred embodiment is not what is being patented. Rather the idea of using an algorithm that calculates revenue share on nodes passed while browsing is being patented herein.

The administrator of the social network may adjust the number of nodes and the percentage revenue shares in the previously suggested algorithms, or they introduce entirely new algorithms that mine the information inherent within nodes so as to compensate creators of content who participate in and build the social network, and associated content archives and marketplaces.

Also shown in FIG. 6 is a method for rewarding builders of stores and owners of nodes that are traversed as the builder of a content archive surfs around and finds content to add to their own store. Administrators of the social network may limit the depth to which a user may see other people's content or other people's friends, based on the degrees of separation. But no matter what, the builders of the nodes ought to benefit when others cme through their nodes in search of content. Such a system was elaborated on in a specific mathematical formulation in a previous section, but the specific mathematical formula of the previous preferred embodiment is not what is being patented. Rather the idea of using an algorithm that calculates revenue share on nodes passed while browsing is being patented herein.

A user 610 is interested in building a content presence. They join and start browsing, passing NODE1 611, NODE2 612, NODE3 613, NODE4 614, and finding content they would love to include in their store 616. The user invites the NODE4 614 user to join their network 615. The NODE4 614 user accepts 617. The user 610 then adds 618 NODE4 614 user's content 616 to his store. An external browser or other user buys 619 the NODE4 616 content 620 from the user's 610 store. The owners of NODES 1-4 are then all compensated by an algorithm that recorded the nodes the original user traversed in finding content for his store.

So it is that enhanced and improved social networks, as well as novel business models and opportunities may be provided for users of the present invention, including creators, aggregators, and owners of entire socially networking systems built with the systems presented herein.

FIG. 7 shows how the user is afforded a full spectrum of digital rights management 704, 705, 706, 707, watermarking 720, and advertising embedding options 702. Uploaded content enjoys a full spectrum of freedom and opportunity in the realm of rights management and distribution, including being distributed in other users' nodes/networks, and exported out into the greater world. Such freedom and opportunity allows users of the system to protect and profit from their content in numerous ways, never before witnessed in the real of social networking, including, displaying content with paid advertising 770 for which the user is compensated, selling content 771, sharing content 772, and exporting content and rights information with standard technologies and standards including rss/rdf/xml 773.

FIG. 8 illustrates the numerous business opportunities gained by defining a social networking node in a novel way, as it marries commercial content to the user's node in a social network. Each node in a preferred embodiment is defined primarily by a user and their content store. Each user is paid for helping build the greater network via a tiered revenue-share system based on nodes' relationships. Hence a greater value for social networks.

The node 851 in FIG. 8 is an expanded representation of nodes (501-505 & 511-514 & 601-605 & 611-614) in FIGS. 5 and 6.

Instead of just including defined relationships and friends, a node 851 in this present invention includes relationships between users and other users 864, users and content 865, content and content 866, content and marketplaces 862, 867, 860. Further relationships may be defined within this node.

Instead of just letting one browse one's network of friends 804, 808, this invention allows one to browse a user's 800, or an owner of a node's 851 storefront, content archive, and display of content. Furthermore, this invention allows users to build nodes so that they might profit from sales of content through their node. Also, as discussed in previous figures, including FIG. 5 and FIG. 6, the owners of nodes may be compensated when content is purchased or viewed with advertising through their node, when their node is traversed by a browser en-route to purchasing or viewing content with advertising, and when other users traverse their nodes in finding and assembling content for their own content stores and archives, proportional to the degree that those stores and archives generate revenue.

The way the system would work in one preferred embodiment according to FIG. 8 is that while userA could include the content 805, 806, 807, 809, 810, 811 of his friends userB 804 and userC 808, he would not be able to include the content, 813, 814, 815 of userD 812, as userD is not his friends. However, should the owner and operators of this network choose, the minimum degrees of separation between nodes that are allowed to share content may be altered. Also, content could be shared on a piece-by-piece basis, with approval required for every piece of content, no matter how close, or how far the users are apart-no matter how many degrees of separation exists between them.

### DETAILED DESCRIPTION—PREFERRED EMBODIMENT SCENARIOS

Photography:

For instance, a photographer opens an account within the context of the present invention and uploads photos for sale. He applies to other photography groups who may accept or reject his photos. If he is accepted into other groups, then his photos will be offered for sale in the groups to which he is accepted, and he will receive a tiered commission when his photos are sold through the other groups.

Other photography groups or photographers might see his photos and invite him to join their groups. He may accept or decline. If he accepts, then his photos will be seen for sale in the other groups, and he will receive a commission.

The same concepts may be applied to bands, modeling agencies, and more, as well as to hybrid storefronts that combine photography, movies, film, books, and more.

Modeling Agency:

An aspiring model uploads her photos and information. She is then invited to join a modeling agency or socially-networked group of models. If she accepts the invitation, the agency offers her as a model, and they will receive a commission for any work they find for her.

Another way a venture might progress is that a talent agent/scout may open an account and begin inviting models to join their group. As an aggregator, the agent will seek out work for her models, and she will receive a commission for any work she finds for them.

Record Label:

An aspiring musician sets up a web page for their band. They see a group within the context of the network, representing a record label, with similar bands as to their own, and they apply to join. If they are accepted, a link is provided back to their page, while a link from their page is given to the new page. A picture or two of their band/albums may appear on the record label's page, and their songs will be offered for sale upon the group's page. The band and the record label will split profits according to a tiered algorithm that is determined by the host of the network, and which is based in some way upon the degrees of separation, as well as other variables.

The original user chooses to encrypt his media files with DRM, charging $1.00 for the right to play the file. A shopper comes in and browses through the social network, traversing different nodes until she happens upon the song and purchases it. The nodes traversed are recorded, and the owner of each node may be compensated according to a tiered compensation system based upon an algorithm chosen and tweaked by the owners of the social network. The final group or storefront may also be included in the algorithm.

The group in the above case behaves as a record label, with the group's leaders actively recruiting bands and scouting songs to sell.

The group's leader invites bands, and bands choose whether or not to accept the invitation. If they are accepted, their songs are sold off the group's site, and the group owner(s) receive a commission based on a tiered network.

Bands can sell one-another's songs from each-other's websites, earning commissions for songs sold.

A drummer can become a record-company executive by starting a group and then recruiting other bands to join.

Artist:

An artist uploads photos of their paintings. The artist finds other similar painter's groups and asks to join. The artist is either accepted or rejected. When the paintings are sold through the other groups, the artist splits the profits with the group according to a tiered commission.

Alternatively, a curator of an online gallery can join and then actively search for artists and painters to be included in their gallery. She invites different artists to join, and when they join, and when their paintings are sold through her storefront, she gets a commission.

In one preferred embodiment, the above artist may meet other artists through the artists she has linked to, and as she builds her store by inviting further artists, the path she traversed to find the artists will be recorded and reflected within the tiered commission structure. The degrees of separation determine the tiered revenue sharing across the different artists' accounts.

Publishing Company:

Similar to photography/music but with books.

Bloggers:

Similar to photography/music but with books.

Hybrid:

A band begins by starting a web page and selling their songs. They then invite a photographer to join their group, and later on a few models. The photographers and models join. A hybrid brand emerges, and everyone shares ecommerce revenues of content sold from the commerce site, or advertising revenues displayed in the content archive.

Rating System:

One preferred embodiment of the present invention may include a rating system, so as to ensure that reputable individuals and groups will prosper, while disreputable groups will decline. The same concepts may be applied to bands, modeling agencies, and more.

### FURTHER OBJECTS AND ADVANTAGES OF INVENTION

In addition to objects and advantages already outlined, this present invention has further objects and advantages:

a) Utility:

This invention is useful in that it allows high-quality archives of content to naturally emerge through a self-selecting process. This invention will be of vast use creators and consumers alike.

It is difficult for an independent creator to compete against the corporate conglomerates, and too, it is difficult for consumers to find quality content in the vast array of independent artists. This invention offers a novel, unobvious method for achieving profitability through social networks, by marrying social networks of users to content, and by marrying social networks to archives and marketplaces of content.

More particularly, this invention offers a novel, unobvious method for achieving profitability through social networks, by marrying social networks to archives and marketplaces of content created by participants in said social networks defining mutually-approved relationships.

b) Novelty:

Various existing social networking systems, including friendster™, linkedin™, and tribe.net™ all support the networking of individuals. This invention rises above and beyond the prior art by supporting the networking of content in a relational database.

Not only does one see a user's friend, but one sees the content of a user's friends, and/or the content a user selected.

c) Unobviousness:

Throughout the social networking sites, there are places for photographers, models, and musicians to gather in groups, but there is nowhere for users to aggregate photographers, musicians, models, and others, and profit from their networking ability by selling goods from the aggregated creators and producers of content.

Throughout the common networking sites, people sign up as individuals. They sign up as models, actors, and musicians.

This invention is non-obvious because the end result of this invention is different from the results of the other social networking sites. The end result of this invention are enhanced archives and marketplaces of models, photography, music, and movies. The new and different result of this present invention are hitherto unseen ecommerce sites of novel record labels, movie distribution centers, and art galleries, riding upon social networks. This invention is novel and non-obvious because through a new form of social/content networking, it results in new revenue streams not yet taken advantage of by any other social networking sites.

This invention is also non-obvious as it counters expert opinion as described elsewhere within this application.

d) Unsuggested Modification:

Nowhere in the prior art does it mention the a social network's potential end result of emergent, high-quality marketplaces and archives centered about networked individuals, when the networks are married to content.

Nowhere in the prior art does it mention the a social network's potential end result of emergent, high-quality marketplaces and archives centered about networked individuals, when the networks are married to content created in part or wholly by said networked individuals.

Nowhere in the prior art has a social network been married to a tiered commission system which computes shared commissions with an algorithm based upon the degrees of separation amongst different users, groups, and nodes in a social network.

Nowhere in the prior art does a social network capitalize upon and share the natural wealth creators endow a network with by defining mutually-approved relationships, by allowing ecommerce and then providing a revenue-sharing program based upon a tiered commission structure wherein revenue is shared in accordance to the degrees of separation that may be recorded both when stores are built, networks are traversed, and content is bought.

e) Unappreciated Advantage:

This invention provides several new advantages. It affords creators new opportunities to come together to sell their content, and it provides consumers with content that has been sifted through a social network.

It provides a novel means for financial profitability for social networks, individual participants in said networks, and creators of content.

f) Solves Prior Inoperablity:

The general unprofitability of social networks on the internet and related business models has been reported throughout the internet and newspapers, and summarized in this present invention's application. Furthermore, U.S. patent application No. 20050154639 states,
“[0005] Likewise, social networks such as Friendster.com, Ryze.com, Linkedln.com and many others have been very popular with consumers for social dating and making professional contacts. However, that none of these social networks have been able to bring forth a viable business model to support their networks, many of which are now used by millions of registered users, is well known and frequently discussed in the eCommerce marketing community.”

This invention offers a pathway to profitability by the unique use of social networks to create emergent content and talent marketplaces.

U.S. patent application No. 20050154639 states,
“[0006] Heretofore many of these social networks have attempted to support their efforts by charging users for memberships, sales of advertising to third party advertisers or a combination of both. Unfortunately the desire of the consuming internet public is online services should be available free of charge, even though this may not be realistic, and attempts to charge for various social network fees have not been successful. (Cite 5,8)”

This invention offers a pathway to profitability by the unique use of social networks to create emergent content and talent marketplaces.

U.S. patent application No. 20050154639 states,
“[0015] U.S. Pat. No. 6,175,831 by Weinreich et al and assigned to Six Degrees, Inc . . . the inventor describes a networking architecture that has been copied an enhanced by many social networks. While the 831 patent describes a personal profile created by a user and the ability to search other registered users' profiles, it does not describe linkage to an accounting system that maintains the earning and dispensing of incentive points for that user as a marketing enhancement for an unrelated commercial enterprise. Weinreich does mention a website could be created where users could list items for “sale, hire, rent, etc” but never mentions earning incentives for auction activities or disposition of those incentives solely due to their participation in a third party eCommerce site with no purchase required. Weinreich does not teach an ancillary accounting system to track points earned and their subsequent dispersal.”

Nowhere does patent #6,175,831 nor any other prior art mention the linking of users with content, nor the linking of a social network with content, nor the linking of an underlying social network to content, so as to foster content marketplaces and archives based upon an underlying social network, thusly inheriting the natural “trustworthiness” of a social network and using it as a arbiter of taste, and also using the nodes of the network within an algorithm that provides a tiered system for sharing revenues.

Weinreich does mention a website could be created where users could list items for “sale, hire, rent, etc,” but he does not mention the emergent beauty of trusted archives and marketplaces of content that could be build upon a system of networked users, nor does he mention using the nodes of the network within an algorithm so as to calculate a tiered system for sharing revenues amongst the users who have built the network. Many such algorithms exist, and this patent application describes a couple, but in no way precludes the use of others which would still fall under the general spirit of the intellectual property claimed by this present invention.

g) Solution of Long-Felt Need:

As discussed and characterized above, although the internet is and ought to be the creator's dream, Weird Al Yankovic was yet making less money sold via downloads through iTunes than he was in traditional CD sales. Hundreds of others prominent musicians wish to be better served, as do tens of thousands of indie creators, including musicians, filmmakers, and photographers. The internet has promised indie creators distribution, while offering consumers greater selection. This invention provides an enhanced solution to this long-felt need-let indie creators define their associations and their rights, and let them profit both from the content they create and the social networks they build. Earlier it was pointed out that Myspace has zero content costs, because they never pay the creators. Furthermore, they never share the advertising revenue generated by the creator's content.

In Web 2.0 Is Reminiscent Of Marx at http://www.cbsnews.com/stories/2006/02/15/opinion/main1320641.shtml Andrew Keen reports the following:
“This is historic,” my friend promised me. “We are enabling Internet users to author their own content. Think of it as empowering citizen media. We can help smash the elitism of the Hollywood studios and the big record labels. Our technology platform will radically democratize culture, build authentic community, create citizen media.” Welcome to Web 2.0 . . . In his mind, “big media”—the Hollywood studios, the major record labels and international publishing houses—really did represent the enemy. The promised land was user-generated online content. In Marxist terms, the traditional media had become the exploitative “bourgeoisie,” and citizen media, those heroic bloggers and podcasters, were the “proletariat.” This outlook is typical of the Web 2.0 movement, which fuses '60s radicalism with the utopian eschatology of digital technology. The ideological outcome may be trouble for all of us . . .

It should be pointed out that in Web 2.0, the user rarely gets to protect and profit form their content. Instead the focus is on empowering and enriching the creator. Mr. Keen continues:
Just as Marx seduced a generation of European idealists with his fantasy of self-realization in a communist utopia, so the Web 2.0 cult of creative self-realization has seduced everyone in Silicon Valley. The movement bridges counter-cultural radicals of the '60s such as Steve Jobs with the contemporary geek culture of Google's Larry Page. Between the book-ends of Jobs and Page lies the rest of Silicon Valley, including radical communitarians like Craig Newmark (of Craigslist.com), intellectual property communists such as Stanford Law Professor Larry Lessig, economic cornucopians like Wired magazine editor Chris “Long Tail” Anderson, and new media moguls Tim O'Reilly and John Batelle.

It should be pointed out that at this moment Google is digitizing books in the library that are still under copyright without giving the authors a penny of their billions upon billions. The present invention would allow authors to protect content so that they get paid every time it is copied or used, if they wish to be paid. The choice of how content is used resides with the creator.
The ideology of the Web 2.0 movement was perfectly summarized at the Technology Education and Design (TED) show in Monterey, last year, when Kevin Kelly, Silicon Valley's über-idealist and author of the Web 1.0 Internet utopia “Ten Rules for The New Economy,” said:
Imagine Mozart before the technology of the piano. Imagine Van Gogh before the technology of affordable oil paints. Imagine Hitchcock before the technology of film. We have a moral obligation to develop technology.
But where Kelly sees a moral obligation to develop technology, we should actually have—if we really care about Mozart, Van Gogh and Hitchcock—a moral obligation to question the development of technology . . .
One of the unintended consequences of the Web 2.0 movement may well be that we fall, collectively, into the amnesia that Kafka describes. Without an elite mainstream media, we will lose our memory for things learnt, read, experienced, or heard. The cultural consequences of this are dire, requiring the authoritative voice of at least an Allan Bloom, if not an Oswald Spengler. But here in Silicon Valley, on the brink of the Web 2.0 epoch, there no longer are any Blooms or Spenglers. All we have is the great seduction of citizen media, democratized content and authentic online communities. And weblogs, course. Millions and millions of blogs.

An added bonus of the present invention is that by building networks of content worth paying for, higher arts will be encouraged. Prominent tastemakers will gather within the realm of the networks afforded by the present invention, as there will be higher-quality that is more worth their time than all the teenage girls posing in underwear on myspace.

22nets provides a way to achieve the long sought-after profitability in social networks—the key is marrying social networks to content, both that created by the individuals in the social network, as well as content and merchandise that exists beyond. Let every user upload and sell songs, photography, and art. Groups of mutually-attracted users will form, providing organic brands for fashion, photography, and more. Users will benefit, as will consumers.

h) Crowded Art:

There is much prior art describing social networking services, but none of them support ways for artists to create networked marketplaces. This advanced and improved use of social networks to define mutual relationships between content, allows the emergence of brand new marketplaces. The addition of digital rights management to a social network will allow it to excel beyond its competitors, by attracting creators who love creating so much that they wish to protect and profit from that which they create.

i) Counters Expert Opinion

The present invention counters renown expert opinions. Corey Doctorow, the esteemed blogger, presented his views on DRM to Microsoft http://www.craphound.com/msftdrm.txt:
Greetings fellow pirates! Arrrrr!
I'm here today to talk to you about copyright, technology and DRM, I work for the Electronic Frontier Foundation on copyright stuff (mostly), and I live in London. I'm not a lawyer—I'm a kind of mouthpiece/activist type, though occasionally they shave me and stuff me into my Bar Mitzvah suit and send me to a standards body or the UN to stir up trouble. I spend about three weeks a month on the road doing completely weird stuff like going to Microsoft to talk about DRM.
I lead a double life: I'm also a science fiction writer. That means I've got a dog in this fight, because I've been dreaming of making my living from writing since I was 12 years old. Admittedly, my IP-based biz isn't as big as yours, but I guarantee you that it's every bit as important to me as yours is to you.
Here's what I'm here to convince you of:
1. That DRM systems don't work
2. That DRM systems are bad for society
3. That DRM systems are bad for business
4. That DRM systems are bad for artists
5. That DRM is a bad business-move for MSFT
It's a big brief, this talk. Microsoft has sunk a lot of capital into DRM systems, and spent a lot of time sending folks like Martha and Brian and Peter around to various smoke-filled rooms to make sure that Microsoft DRM finds a hospitable home in the future world. Companies like Microsoft steer like old Buicks, and this issue has a lot of forward momentum that will be hard to soak up without driving the engine block back into the driver's compartment. At best I think that Microsoft might convert some of that momentum on DRM into angular momentum, and in so doing, save all our asses.
Let's dive into it.
—From http://www.craphound.com/msftdrm.txt

The present invention-22nets—counter's Corey Doctorow's expert opinion by affording a system that provides a means to artists, authors, and creators to protect and profit form their work as they see fit. The 22nets system does not say that DRM is a bad thing, but it says that the right of the creator to choose whether or not use DRM to protect their content, echoing the spirit of the United States Constitution is a good thing.

Another expert, Larry Lessig—the famous Stanford law professor, author of numerous books, and eminent blogger, states, (http://www.lessig.org/blog/archives/003353.shtml), Lessig writes,
So let me be as clear as possible here (though saying the same thing I've always said): We should be building a DRM-free world. We should have laws that encouraged a DRM-free world. We should demonstrate practices that make compelling a DRM-free world. All of that should, I thought, be clear.—http://www.lessig.org/blog/archives/003353.shtml

The present invention—22nets—counters Lessig's expert opinion by providing a system that affords DRM as an option to all creators and artists. 22nets does not advocate a DRM-free world, as that would limit the freedom of companies to build DRM systems and creators to enjoy and profit from DRM systems.

j) More On a Solution To a Long-Felt Need

While the above experts see no need for an artist to protect their works via DRM, the artists, including famous acts such as Kid Rock, Elton John, Lou Reed, Puff Daddy, George Lucas, Metallica, Eminem, Trent Reznor, Sir Paul McCartney, generally see the need, as discussed above. 22nets sides with the artists, affording them a better and superior means to protect and profit from their work. 22nets, in effect, creates a system that Sir Paul McCartney and George Lucas would trust, thusly affording a superior method for content distribution. The following quotes further illustrate the need for a 22nest system, as well as the solution that 22nets offers to a long-felt need:
Just because the market has shifted so dramatically. A lot of people are getting very worried about piracy. That has really eaten dramatically into the sales. It really just came down to, there may not be a market when I wanted to bring it out, which was like, three years from now. So rather than just sit by and watch the whole thing fall apart, better to bring it out early and get it over with.—George Lucas
Godard Slams Tarantino:
From: http://www.imdb.com/news/wenn/2005-05-20
Legendary director Jean-Luc Godard has hit out at Quentin Tarantino—one of his biggest admirers—for using the title of one of his 1960s films without financially rewarding him. Maverick film-maker Tarantino took the name Band A Parte (Band Of Outsiders) from the New Wave icon's 1964 movie and used it as the name for his production company. But Breathless filmmaker Godard, 74, is less than impressed by the Pulp Fiction director's intended flattery. He says, “Tarantino named his production company after one of my films. He would have done better to give me some money.”
As an artist and songwriter I believe that this is an issue that needs to be looked at and taken very seriously. In what other industry can someone take a product, not created by themselves, make money from the use of that product and not compensate the original creator? Someone needs to take a stand and protect the songwriters and artist.”—Victoria Shaw, country music singer/songwriter
“I couldn't believe it when I found out that this Napster was linking thousands of people to the new Notorious BIG album “Born Again,” a week before it even hit the streets. This album is a labor of love from Notorious BIG's friends to the man, his kids, the rest of his family and everyone else whose lives will never be the same since BIG passed. BIG and every other artist Napster abuses deserve respect for what they give us.”—Sean “Puffy” Combs, CEO, Bad Boy Entertainment, Inc.
“Artists, like anyone else, should be paid for their work.”—Lou Reed
“I am excited about the opportunities presented by the Internet because it allows artists to communicate directly with fans. But the bottom line must always be respect and compensation for creative work. I am against Internet piracy and it is wrong for companies like Napster and others to promote stealing from artists online.”—Elton John
People want the truth. Even if they can't handle it, they want it. They may want to look at it as a story or music so they can distance themselves from it, but they want it.—50 Cent
“ . . . . Just because technology exists where you can duplicate something, that doesn't give you the right to do it. There's nothing wrong with giving some tracks away or bits of stuff that's fine. But it's not everybody's right. Once I record something, it's not public domain to give it away freely. So I stand behind Dr. Dre and Metallica and support them. And that's not trying to be the outdated musician who is trying to ‘stop technology. I love technology. Technology is here to stay . . . —Trent Reznor of Nine Inch Nails, Boston Globe, May 5, 2000

I'm sorry; when I worked 9 to 5, I expected to get a f--king paycheck every week. It's the same with music; if I'm putting my f--king heart and all my time into music, I expect to get rewarded for that. I work hard and anybody can just throw a computer up and download my s--t for free. That Napster s--t, if that gets any bigger, it could kill the whole purpose of making music. It's not just about the money. It's the thrill of going to the store; you can't wait till that artist's release date, taking the wrapper off the CD and putting the CD in to see what it sounds like. I've seen those little sissies on TV, talking about [how] ‘The working people should just get music for free,’ I've been a working person. I never could afford a computer, but I always bought and supported the artists that I liked. I always bought a Tupac CD, a Biggie CD, a Jay-Z CD. If you can afford a computer, you can afford to pay $16 for my CD. Eminem, all of Sound, May 17,
Let's get the obvious out of the way: This is not just about money (as some of the more cynical people will think). This is as close as you get to what's right and what's wrong. Metallica have always been in favor of giving the fans as much access as possible to our music. This includes taping sections at our concerts, and streaming our music via our website. And while we certainly revere our fans for their continued support and desire for our music, we must stress that the open trading of any copyrighted material is, in effect, the looting of our art. And that is something that no artist can, in their right mind, condone. We are in the business of art. This is a walking contradiction if ever there was one. However, there is no denying it. On the artistic side, Metallica create music for ourselves first and our audience second. With each project, we go through a grueling creative process to achieve music that we feel is representative of Metallica at that very moment in our lives. We take our craft—whether it be the music, the lyrics, or the photos and artwork—very seriously, as do most artists. It is therefore sickening to know that our art is being traded, sometimes with an audio quality that has been severely compromised, like a commodity rather than the art that it is. From a business standpoint, this is about piracy—a/k/a taking something that doesn't belong to you; and that is morally and legally wrong. The trading of such information—whether it's music, videos, photos, or whatever—is, in effect, trafficking in stolen goods. Back to the obvious: Very successful recording artists are compensated extremely well for what they do. For every Metallica, however, there are an endless number of bands who rely on what ever they can get in royalties to survive. And while we all like to take shots at the big, bad record companies, they have always reinvested profits towards exposing new bands to the public (although sometimes not the RIGHT bands). Without this exposure, many fans would never have the opportunity to learn about tomorrow's bands today. Napster and other such sites were obviously not conceived to lose money. They, like the labels, must make money or they're out of business. And whatever money they are generating from their site is dirty money. It's being taken out of the hands of the artist and the record labels and put into the hands of another corporation.—Lars Ulrich of Metallica

It is therefore an object of the invention to allow artists, aggregators, producers, and creators to monetize their creations, providing them with a full spectrum of popular DRM choices, so that they might choose the best for themselves.

It is another object of the invention to allow social networks achieve profitability in novel ways.

It is another object of the invention to provide artists, users, creators, and aggregators the ability to capitalize upon and profit from the intrinsic value within social networks they build.

It is another object of the invention to afford creators unprecedented freedom in rights management, distribution opportunities, importing and exporting content, and creating social networks in the spirit of the United States Constitution wherein the creators are the primary beneficiaries.

The present invention is directed to a networked database having a plurality of records corresponding to individuals and associated creative works and content, more particularly to a networking database in which the records of music, art, photography, poetry, and literature are inter-linked by defined relationships to other creative works and individuals. When users join, they may upload their own creative work, and/or link to other external works. They then may seek to join other groups, or wait to be invited. Through mutual interactions, users define the content and users that are associated with their groups. Over time high-quality, trusted groups and ecommerce presences emerge, lending profitability to the social network model, and affording novel commercial opportunities to talented individuals.

At least two vital features mark the present invention as novel and unique.

1) The association of commercial content with individuals in a social network allow for novel ecommerce presences to emerge, as well as novel business models, empowering creators, producers, aggregators and social network systems based on the present invention.

2) The ability for creators to define the rights to their content and protect it will afford creators news means and methods for profiting from their content. Indeed, it would be hard to conceive of a social network with the ecommerce components described within this current invention without affording creators the fundamental options to define and protect their rights as the United States Constitution provides for. The United States Constitution states, “The Congress shall have Power to promote the Progress of Science and useful Arts, by securing for limited Times to Authors and Inventors the exclusive Right to their respective Writings and Discoveries;” This invention is novel in that it provides a creator, within the context of a social network, the ability to use readily available, yet largely derided, technologies to encrypt and secure their content, such as Microsoft's DRM technologies. The present invention provides the content creator a full spectrum of rights management and monetizing options, from sales of encrypted media, to creative commons licenses, to tagging said content with advertising.

Either of the above features would afford novel business models and social networks.

Either of the above features, when added to existing social networks and content aggregators such as revver.com™, myspace.com™, friendster.com™, youtube.com™, and lulu.com™, would grant existing social networks and content aggregators hitherto unknown advantages in the realm of commerce. Either of the above features would enhance the business models of existing systems, while also enhancing the business opportunities of the users.

America is the wealthiest nation not because she has the highest taxes, but because she has the lowest. America is the wealthiest nation not because she claims the right to every individual's property, but because she lets every individual own property. So it is that a first mover in the realm of content aggregators and social networkers who afford their users with the ability to define rights to their content, protect it as they see fit, and thusly profit from it, will become the wealthiest. Those entities who afford content creators with improved means for owning and profiting from their works will become wealthier entities. Just as no nation has ever taxed itself into prosperity, no content archive nor record label has ever achieved long-term profitability by claiming complete, or an overwhelmingly large, ownership of the content.

This invention contains the elements of the killer app—an invention that empowers creators and artists as never before. So many authors/artists/creators ride into Hollywood, and they don't have an opportunity to make money off their content—off their headshots, reels, and portfolios. Instead they are expected to build social networks that empower major media corporations such as Fox Newscorp. This invention allows creators of all kinds—the talent—to more readily profit form the digital economy, thusly enhancing the digital economy. A rising tide lifts all boats, and the excitement and benefits of this present invention, which throws off the shackles of yesteryear's web 1.0/2.0 ways of thinking, will manifest themselves in numerous novel and improved business opportunities.

This invention represents certain aspects of an online video game, but one gets to quickly and easily create real ecommerce presences representing photography shops, record labels, modeling agencies, and more. Thus this invention should inherit many of the features that make online gaming popular. Indeed, flickr was started as online game, and the present invention takes it beyond flickr, as it allows one to get paid. Indeed, the present invention will allow one to create record companies, stock photography shops, modeling agencies, and more.

In accordance with the present invention, there is provided a method for creating a collection of networked content archives and marketplaces fostered by a networking database containing a plurality of records for creative content and individuals in which individuals and content are connected to other individuals and content in the database by defined relationships determined by the creators and/or viewers of said content. Distinct content marketplaces naturally emerge based on mutual relationships defined by creators and viewers in the said networking database. A tiered commission system, proportional to the degrees of separation in the network, may provide a revenue share for creators and viewers who create content and/or marketplaces within a network. Each creator and/or viewer has the opportunity to define the relationship with content which may be confirmed or denied by other content creators, aggregators, and viewers. A ratings system and interactive communication between individuals, including emailing and instant messaging in the context of a database service provider, provide a method of constructing the networking database, naturally ranking users and content in a self-selecting hierarchy. The method includes allowing registered individuals, be they creators or viewers, to identify other individuals and/or content and define therewith a relationship. The further individuals then, in turn, establish their own defined relationships with still other content, creators, and viewers. Over time, uniquely defined marketplaces of content emerge based upon the underlying networks.

This invention provides method for creating a collection of networked content archives and marketplaces fostered by a networking database containing a plurality of records for creative content and individuals in which individuals and content are connected to other individuals and content in the database by defined relationships determined by the creators and/or viewers of said content. Distinct content marketplaces naturally emerge based on mutual relationships defined by creators and viewers in the said networking database. A tiered commission system, proportional to the degrees of separation in the network, may provide a revenue share for creators and viewers who create content and/or marketplaces within a network. Each creator and/or viewer has the opportunity to define the relationship with content which may be confirmed or denied by other content creators, aggregators, and viewers. A ratings system and interactive communication between individuals, including emailing and instant messaging in the context of a database service provider, provide a method of constructing the networking database, naturally ranking users and content in a self-selecting hierarchy. The method includes allowing registered individuals, be they creators or viewers, to identify other individuals and/or content and define therewith a relationship. The further individuals then, in turn, establish their own defined relationships with still other content, creators, and viewers. Over time, uniquely defined marketplaces of content emerge based upon the underlying networks.

This patent pertains to a method and apparatus that provides a novel means for establishing and growing content businesses related to photography, music, video, film, movies, fashion, and more.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

The present invention pertains to a method for creating content archives and marketplaces fostered by a social network networking database containing a plurality of records for individuals and content in which individuals and content are connected to other individuals and content in the database by mutually defined relationships determined by the creators, uploaders, aggregators, and/or viewers of said content. The novel social network described herein allows those who create and upload content, as well as those who aggregate content and build out social networks, to profit in ways hitherto unseen in other social networks. Higher-quality archives are encouraged as users are afforded the ability to profit via sales of content and advertising. Distinct content marketplaces naturally emerge based on mutual relationships defined by creators and viewers in the said networking database. A tiered commission system, proportional to the degrees of separation in the network, provides a revenue share for creators and viewers who participate in and create content and/or marketplaces within a network. The inherent information within nodes of the social network is mined so as to afford users with a tiered revenue-sharing system. Each creator and/or viewer has the opportunity to define the relationship with content which may be confirmed or denied by other content creators, aggregators, and viewers. A ratings system and interactive communication between individuals, including emailing and instant messaging in the context of a social network, provide a method of constructing the networking database, naturally ranking users and content in a self-selecting hierarchy. The method includes allowing registered individuals, be they creators or viewers, to identify other individuals and/or content and participate in defining therewith a relationship. The further individuals then, in turn, establish their own defined relationships with still other content, creators, and viewers. Over time, uniquely defined archives and marketplaces of content emerge based upon the underlying networks of relationships. The administrators of the networking system can amend the revenue-sharing algorithm via which revenue is shared across nodes, based n degrees of separation and other factors. Providing users with a full spectrum of digital rights management further enhances this invention by enhancing content creators and owners ability to protect and profit from their content, through sales of content, and via advertising sold in conjunction with the display of the content. The potential for building improved method of distribution which more greatly empower the creators of content and participants in social networks and builders of social networks is disclosed herein.

This present invention pertains to a collection of networked content archives and marketplaces fostered by a networking database containing a plurality of records for creative content and individuals in which individuals and content are connected to other individuals and content in the database by defined relationships determined by the creators and/or viewers of said content. Distinct content marketplaces naturally emerge based on mutual relationships defined by creators and viewers in the said networking database. A tiered commission system, proportional to the degrees of separation in the network, may provide a revenue share for creators and viewers who create content and/or marketplaces within a network. A means for affording creators with a full spectrum of digital rights management is afforded. Each creator and/or viewer has the opportunity to define the relationship with content which may be confirmed or denied by other content creators, aggregators, and viewers. A ratings system and interactive communication between individuals, including emailing and instant messaging in the context of a database service provider, provide a method of constructing the networking database, naturally ranking users and content in a self-selecting hierarchy. The method includes allowing registered individuals, be they creators or viewers, to identify other individuals and/or content and define therewith a relationship. The further individuals then, in turn, establish their own defined relationships with still other content, creators, and viewers. Over time, uniquely defined marketplaces of content emerge based upon the underlying networks.

Although the above descriptions of the present invention contain many specifities, these should not be construed as limiting the scope of the invention, but merely providing illustrations of some of the presently preferred embodiments of this invention. For example, the invention could me manifested upon numerous software architectures, and the general spirit and scope of the invention should be determined by the appended claims and their legal equivalents, rather than by the examples given.

Having thus described the invention, what is desired to be protected by Dr. Elliot McGucken's Patent is presented in the subsequently appended claims.

What is claimed is:

1) A method for creating networked, ranked, branded archives and marketplaces of content based upon interactions of creators, content aggregators, browsers, users, and consumers in the context of a mutually-defined social network.

2) Where the user IDs of users in claim 1 are associated with IDs of content uploaded by said users, and said content IDs are tracked as content is viewed, sold, and archived throughout the network, so as to compensate said users with shares in revenue generated via ecommerce and advertising.

3) Where the said creators, content aggregators, and browsers in claim 1 are afforded the opportunity to rate and rank content, and where said groups may be assigned overall ratings proportional to the average ratings of all content in said groups.

4) Where the said creators, content aggregators, and browsers in claim 1 are afforded the opportunity to create groups at social networking nodes and invite said creators, content aggregators, and browsers, along with the content associated with their user IDs and in their respective networks, to join said groups at said nodes, and where the said creators, content aggregators, and browsers can choose to accept or reject the invitation from other creators to join said groups and nodes and have their associated content displayed and sold in said groups and nodes.

5) Where the said creators, content aggregators, and browsers in claim 1 can create content networks overlying said mutually-defined social network in claim 1, wherein content is sold and revenues are shared, based upon degrees of separation in social network of mutually defined relationships.

6) Wherein a tiered commission system tied to the archives and marketplaces of claim 1, and based on algorithm proportional to the degrees of separation of nodes in the network traversed in the buyer's act of entering the site at a specific node and traversing other nodes en route to the node where the said content is purchased, may provide a revenue share for users, be they creators or aggregators or viewers, who create nodes within said network of claim 1.

7) Wherein a tiered commission system tied to the archives and marketplaces of claim 1, and based on algorithm proportional to the degrees of separation of nodes in the network traversed in a node builder's act of entering the social network in claim 1 and locating content for their node's ecommerce presence and building their network vi mutually defined relationships within the said social network, may provide a revenue share for creators of nodes within said network of claim 1.

8) Where content and products from external vendors with established affiliate relationships may be included in the context of said groups in claim 1.

9) Where the method in claim 1 for creating networked, ranked, branded archives and marketplaces includes an AJAX interface for easy drag-and-drop arrangement of content, groups, friends, users, and ecommerce storefronts.

10) Wherein instances of the said networked archives of claim 1 offer users a full spectrum of rights management for content, thusly promoting the arts by allowing creators and producers to protect their private property.

11) Wherein instances of the said networked archives of claim 1 offer users a full spectrum of rights management, including traditional copyright, Creative Commons licenses, proprietary digital rights management solutions, open source digital rights management solutions, and other methods of encryption, thusly promoting the arts by allowing the creator to protect their private property.

12) Wherein instances of the said networked archives of claim 1 offer users the ability to sell advertising on top of and around their content and the content within their network.

13) Wherein instances of the said networked archives of claim 1 offer users the ability to sell advertising on top of and around their content and the content, and users may profit off each-others content in their social networks based upon a tiered commission system that is tied to an algorithm that is based on the nodes traversed in the social network during the building and browsing of said network.

14) Wherein content within the archives in claim 1 may be easily imported and exported, along with their rights, using common standards and technologies.

15) A method for creating networked, ranked archives of content based upon interactions of creators, content aggregators, browsers, and/or consumers in the context of a mutually-defined social network where creators and all uploaders of content are afforded a means for full spectrum of rights management options for said content.

16) Wherein the creators and uploaders of content in claim 15 are afforded a full spectrum of watermarking tool for said content, full spectrum of rights management including Creative Commons licenses, and proprietary proprietary and open source and digital rights management systems.

17) Wherein users are provided an easy means for importing and exporting content they upload to the said archives in claim 15, where means for exporting and importing content may include rss, rdf, and xml feeds.

18) In a computer system including a server computer and a database of registered users and registered content that stores for each registered user and piece of content, a user ID of the registered user and a content ID and rights information for each piece of content associated with said registered user and a set of user IDs of registered users who are directly connected to the registered user, and a set of content IDs represented content of registered users who are directly connected to the registered user or other registered content, a method for connecting a first registered user to a second registered user through one or more other registered users, a method for connecting the content of first registered user to content of a second registered user through one or more registered users, the method comprising the steps of: setting a maximum degree of separation (Nmax) of at least two that is allowed for connecting any two registered users and their related content, wherein two registered users and their associated content who are directly connected are deemed to be separated by one degree of separation and two registered users and their associated content who are connected through no less than one other registered user are deemed to be separated by two degrees of separation and two registered users and their associated content who are connected through no less than N other registered users are deemed to be separated by N+1 degrees of separation; searching for the user ID and content IDs of the second registered user in the sets of user and content IDs that are stored for registered users and their associated content who are less than Nmax degrees of separation away from the first registered user and their associated content, and not in the sets of user IDs and content IDs that are stored for registered users who are greater than or equal to Nmax degrees of separation away from the first registered user, until the user ID and associated content IDs of the second registered user is found in one of the searched sets; and connecting the first registered user and their associated content to the second registered user and their associated content if the user ID and/or content IDs of the second registered user is found in one of the searched sets, wherein the method limits the searching of the second registered user in the sets of user IDs and/or content IDs that are stored for registered users who are less than Nmax degrees of separation away from the first registered user, such that the first registered user and their associated content and the second registered user and their associated content who are separated by more than Nmax degrees of separation are not found and connected.

19) Where the said content in claim 18 may be sold in marketplaces which generate revenue via ecommerce and displayed in archives which generate revenue via advertising, and where said generated revenues are split amongst users according to algorithms that are based on the nature and degree of the said connections defined by said users in claim 18.

20) Where said users in claim 18 are offered a full spectrum of digital rights management, ecommerce, and advertising options so as to facilitate building revenue-generating content and marketplaces and archives, and where said generated revenues are split amongst users according to algorithms that are based on the nature and degree of the said connections defined by said users in claim 18.
